(19) United States
(12) Patent Application Publication
(10) Pub. No.: US 2010/0157430 A1
(43) Pub. Date: Jun. 24, 2010

(54) AUTOMOTIVE DISPLAY SYSTEM AND DISPLAY METHOD

(75) Inventors: Aira Hotta, Kanagawa-ken (JP); Takashi Sasaki, Kanagawa-ken (JP); Haruhiko Okumura, Kanagawa-ken (JP); Masatoshi Ogawa, Saitama-shi (JP); Osamu Nagahara, Tokyo (JP); Tsuyoshi Hagiwara, Tokyo (JP); Kazuo Horiuchi, Kanagawa-ken (JP); Naotada Okada, Kanagawa-ken (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/568,038

(22) Filed: Sep. 28, 2009

(30) Foreign Application Priority Data
Dec. 22, 2008 (JP) 2008-325550

(51) Int. Cl. G02B 27/01

(52) U.S. Cl. 359/630; 353/13

(57) ABSTRACT

An automotive display system includes a frontward information acquisition unit, a position detection unit and an image projection unit. The frontward information acquisition unit acquires frontward information. The frontward information includes information relating to a frontward path of a vehicle. The position detection unit detects a position of one eye of an image viewer riding in the vehicle. The image projection unit generates a first virtual image at a corresponding position in scenery of the frontward path based on the frontward information acquired by the frontward information acquisition unit and projects a light flux including an image including the generated first virtual image toward the one eye of the image viewer based on the detected position of the one eye. The first virtual image has a size corresponding to at least one of a vehicle width and a vehicle height.

### CROSS-REFERENCE TO RELATED APPLICATIONS

This application is based upon and claims the benefit of priority from the prior Japanese Patent Application No.2008-325550, filed on Dec. 22, 2008; the entire contents of which are incorporated herein by reference.

### BACKGROUND OF THE INVENTION

1. Field of the Invention

This invention relates to an automotive display system and a display method.

2. Background Art

HUDs (Head-Up Displays) are being developed as automotive display devices to project vehicle information such as driving information including the speed of the vehicle, navigation information to the destination, and the like onto a windshield to allow simultaneous visual identification of external environment information and the vehicle information.

The HUD can present an intuitive display to the image viewer, and the display of information such as the route display can be performed matched to the background viewed by the driver. Technology to display, for example, an image of a virtual vehicle and the like on the HUD to perform travel support has been proposed.

For example, JP 3675330 discusses a HUD to control the display of a virtual leading vehicle based on the frontward street conditions and the traveling state of one's vehicle. The virtual leading vehicle is used to congruously and moderately convey information to the driver relating to the street conditions such as obstacles and curves frontward of one's vehicle to allow driving operations according to the street conditions.

For example, JP 4075743 discusses a HUD to start displaying vehicle width information of one's vehicle when entering a road narrower than a prescribed width and automatically stop the display thereof when a wider road is entered. In such a case, the HUD displays tire tracks, an imaginary vehicle, and the like as the vehicle width information of one's vehicle; detects whether or not an oncoming vehicle will be contacted; and performs a display thereof.

Thus, a HUD can perform travel support by displaying a symbol of a virtual leading vehicle, etc., corresponding to the width of one's vehicle and the like.

In the case of a normal HUD, the display of the HUD is observed by both eyes. The depth position of the virtual image displayed by the HUD is an optically designed position (optical display position) set in many cases at a position 2 to 3 m frontward of the driver. Accordingly, in the case of a binocular HUD, the display object of the HUD is recognized as a double image and therefore is extremely difficult to view when the driver attempts to simultaneously view the display of the HUD while viewing distally during operation. Conversely, when the driver attempts to view the display of the HUD, binocular parallax causes the display image to be recognized 2 to 3 m ahead. Therefore, it is difficult to recognize the display image simultaneously with a distal background.

Because the display image of the HUD is reflected by the windshield and the like to be observed, parallax (a double image) occurs due to the thickness of the reflection screen of the windshield, thereby making it difficult to view the display.

Thus, to solve the difficulties viewing due to binocular parallax, monocular HUDs have been proposed in which the display image is observed by one eye. For example, known technology avoids binocular parallax and presents a display image to only one eye to make the depth position of the display object of the HUD appear more distally than the optical display position.

Technology has been proposed to present the display image only to one eye to prevent the double image recited above (for example, refer to JP-A 7-228172 (1995)).

However, because the recognized depth position of a monocular HUD greatly depends on the background position, the error of the recognized depth position increases. Accordingly, new technology is needed to allow the perception of a virtual leading vehicle and the like at any depth position with high positional precision to perform travel support using a monocular HUD.

### SUMMARY OF THE INVENTION

According to an aspect of the invention, there is provided an automotive display system, including: a frontward information acquisition unit configured to acquire frontward information, the frontward information including information relating to a frontward path of a vehicle; a position detection unit configured to detect a position of one eye of a image viewer riding in the vehicle; and an image projection unit configured to generate a first virtual image at a corresponding position in scenery of the frontward path based on the frontward information acquired by the frontward information acquisition unit and project a light flux including an image including the generated first virtual image toward the one eye of the image viewer based on the detected position of the one eye, the first virtual image having a size corresponding to at least one of a vehicle width and a vehicle height.

According to another aspect of the invention, there is provided a display method, including: generating a first virtual image at a corresponding position in scenery of a frontward path of a vehicle and generating a light flux including an image including the generated first virtual image based on frontward information including information relating to the frontward path, the first virtual image having a size corresponding to at least one of a vehicle width and a vehicle height; and detecting a position of one eye of a image viewer riding in the vehicle and projecting the light flux toward the one eye of the image viewer based on the detected position of the one eye.

### BRIEF DESCRIPTION OF THE DRAWINGS

FIG. 1 is an automotive display system according to a first embodiment of the invention;

FIG. 2 is the operating state of the automotive display system according to the first embodiment of the invention;

FIGS. 3A to 3C are operations of the automotive display system according to the first embodiment of the invention;

FIG. 4 is the stopping distance of the vehicle;

FIG. 5 is a graph illustrating the characteristics of the automotive display system according to the first embodiment of the invention;

FIGS. 6A and 6B are schematic views illustrating a coordinate system of the automotive display system according to the first embodiment of the invention;

FIGS. 7A to 7C are schematic views illustrating coordinates of the automotive display system according to the first embodiment of the invention;

FIG. 8 is a flowchart illustrating the operation of the automotive display system according to the first embodiment of the invention;

FIG. 9 is the configuration and the operation of the automotive display system according to the first embodiment of the invention;

FIGS. 10A and 10B are operating states of the automotive display system according to the first embodiment of the invention;

FIG. 11 is the configuration of the automotive display system according to the first example of the invention;

FIG. 12 is the configuration of the automotive display system according to a second example of the invention;

FIG. 13 is the configuration of an automotive display system according to a third example of the invention;

FIG. 14 is the configuration of an automotive display system according to a fourth example of the invention;

FIG. 15 is the configuration of an automotive display system according to a fifth example of the invention;

FIG. 16 is a flowchart illustrating the operation of the automotive display system according to the sixth example of the invention; and

FIG. 17 is a flowchart illustrating the display method according to the second embodiment of the invention.

### DETAILED DESCRIPTION OF THE INVENTION

Embodiments of the invention will now be described in detail with reference to the drawings.

In the specification and drawings, components similar to those described above in regard to a drawing thereinabove are marked with like reference numerals, and a detailed description is omitted as appropriate.

### First Embodiment

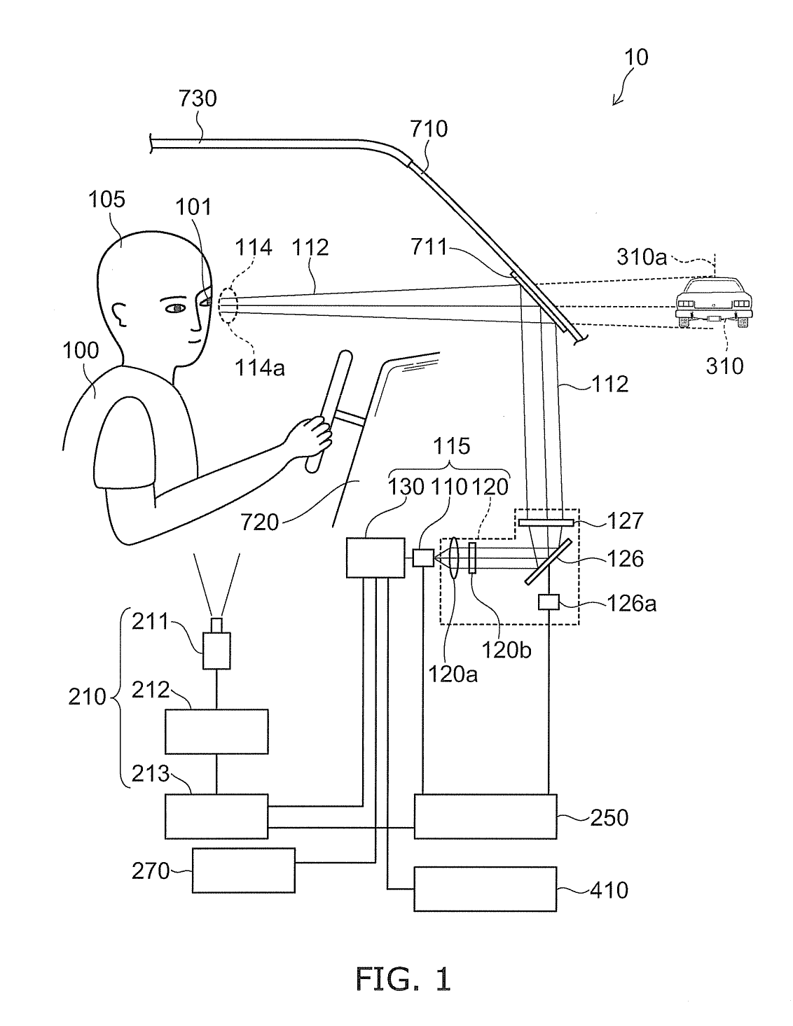

FIG. 1 is a schematic view illustrating the configuration of an automotive display system according to a first embodiment of the invention.

An automotive display system 10 according to the first embodiment of the invention illustrated in FIG. 1 includes a frontward information acquisition unit 410, a position detection unit 210, and an image projection unit 115.

The frontward information acquisition unit 410 acquires frontward information including information relating to a frontward path of a vehicle 730.

The position detection unit 210 detects a position of one eye 101 of an image viewer 100 riding in the vehicle 730.

The image projection unit 115 generates a first virtual image at a position corresponding to the frontward information in scenery of the frontward path based on the frontward information acquired by the frontward information acquisition unit 410 and projects a light flux 112 including an image including the generated first virtual image toward the one eye 101 of the image viewer 100 based on the detected position of the one eye 101. The first virtual image has a size corresponding to at least one of a width and a height of the vehicle 730 (a vehicle width and a vehicle height of the vehicle 730).

The vehicle 730 is a vehicle such as, for example, an automobile. The image viewer 100 is a driver (operator) that operates the automobile. In other words, the vehicle 730 is a vehicle, i.e., the driver's vehicle, in which the automotive display system 10 according to this embodiment is mounted.

The frontward information includes information relating to the frontward path of the vehicle 730. In the case of a branch point and the like, the frontward information includes information relating to the frontward path where the vehicle 730 is estimated to travel and includes the configurations of streets, intersections, and the like.

The first virtual image is an image corresponding to at least one of a width and a height of the vehicle 730. The first virtual image may be an image including, for example, the configuration of the vehicle 730 as viewed from the rear, an image schematically modified from such an image, a figure and the like such as a rectangle indicating the width and the height of the vehicle 730, and various lines. The case will now be described where a virtual leading vehicle image based on the vehicle 730 is used as the first virtual image.

Specific examples are described below for the derivation of the position in the frontward information where the virtual leading vehicle image (the first virtual image) is disposed and the disposition of the virtual leading vehicle image in the image.

As illustrated in FIG. 1, the automotive display system 10 is provided, for example, in the vehicle 730 such as an automobile, that is, for example, in an inner portion of a dashboard 720 of the vehicle 730 as viewed by the image viewer 100, i.e., the operator.

The image projection unit 115 includes, for example, an image data generation unit 130, an image formation unit 110, and a projection unit 120.

The image data generation unit 130 generates data relating to an image including the virtual leading vehicle image based on the frontward information acquired by the frontward information acquisition unit 410 and the position of the detected one eye 101 of the image viewer 100.

An image signal including the image data generated by the image data generation unit 130 is supplied to the image formation unit 110.

The image formation unit 110 may include, for example, various optical switches such as an LCD, a DMD (Digital Micromirror Device), and a MEMS (Micro-electro-mechanical System). The image formation unit 110 forms an image on a screen of the image formation unit 110 based on the image signal including the image data which includes the virtual leading vehicle image from the image data generation unit 130.

The image formation unit 110 may include a laser projector, an LED projector, and the like. In such a case, a laser beam forms the image.

The case will now be described where an LCD using an LED as the light source is used as the image formation unit 110. Devices can be downsized and power can be conserved by using an LED as the light source.

The projection unit 120 projects the image formed by the image formation unit 110 onto the one eye 101 of the image viewer 100.

The projection unit 120 may include, for example, projection lenses, mirrors, and various optical devices controlling the divergence angle (the diffusion angle). In some cases, the projection unit 120 includes a light source.

In this specific example, an imaging lens 120a, a lenticular lens 120b controlling the divergence angle, a mirror 126, and an aspherical Fresnel lens 127 are used.

The light flux 112 emerging from the image formation unit 110 passes through the aspherical Fresnel lens 127 via the imaging lens 120a, the lenticular lens 120b, and the mirror 126; is reflected by, for example, a reflector (semi-transparent reflector) 711 provided on a windshield 710 (transparent plate) of the vehicle 730 in which the automotive display system 10 is mounted; and is projected onto the one eye 101 of the image viewer 100. The image viewer 100 perceives a virtual image 310 formed at a virtual image formation position 310a via the reflector 711. Thus, the automotive display system 10 can be used as a HUD. The virtual leading vehicle image, for example, may be used as the virtual image 310.

Thus, the light flux 112 having a controlled divergence angle reaches the image viewer 100 and the image viewer 100 views the image with the one eye 101. Here, the spacing between the eyes of the image viewer 100 is an average of 6 cm. Therefore, the image is not projected onto both eyes by controlling the width of the light flux 112 on a head 105 of the image viewer 100 to about 6 cm. It is favorable to project the image onto the dominant eye of the image viewer 100 for ease of viewing the image.

Although the lenticular lens 120b is used to control the divergence angle of the light flux 112 recited above, a diffuser plate and the like having a controlled diffusion angle also may be used.

The angle of the mirror 126 may be adjustable by a drive unit 126a. Instead of a plane mirror, the mirror 126 may include a concave mirror as a reflective surface having a refractive power. Also in such a case, the angle thereof may be changed by the drive unit 126a. Although distortion of the displayed image may occur depending on the angle of the mirror 126, etc., an image without distortion can be presented to the image viewer 100 by performing a distortion correction by the image data generation unit 130.

Various modifications of the image projection unit 115 are possible as described below in addition to the specific examples recited above.

On the other hand, the position detection unit 210 detects the one eye 101 of the image viewer 100 onto which the image is projected. The position detection unit 210 may include, for example, an imaging unit 211 that captures an image of the image viewer 100, an image processing unit 212 that performs image processing of the image captured by the imaging unit 211, and a calculation unit 213 that detects by determining the position of the one eye 101 of the image viewer 100 based on the data of the image processing by the image processing unit 212.

The calculation unit 213 detects using, for example, technology relating to personal authentication recited in JP 3279913 and the like to perform face recognition on the image viewer 100, calculate the positions of eyeballs as facial parts, and determine the position of the one eye 101 of the image viewer 100 onto which the image is projected.

The imaging unit 211 is disposed, for example, frontward and/or sideward of the driver's seat of the vehicle 730 to capture an image of, for example, the face of the image viewer 100, i.e., the operator; and the position of the one eye 101 of the image viewer 100 is detected as recited above.

This specific example further includes a vehicle information acquisition unit 270 that acquires information relating to the traveling state and/or the operating state of the vehicle 730. The vehicle information acquisition unit 270 may detect, for example, the traveling speed of the vehicle 730, the continuous travel time, and/or the operating state such as the operation frequency of the steering wheel and the like. The data relating to the operating state of the vehicle 730 acquired by the vehicle information acquisition unit 270 is supplied to the image projection unit 115. Specifically, the data is supplied to the image data generation unit 130. Based on such data, the image data generation unit 130 can control the generation state of the data relating to the virtual leading vehicle image as described below. However, it is sufficient that the vehicle information acquisition unit 270 is provided as necessary. For example, the various data relating to the vehicle 730 acquired by the vehicle information acquisition unit 270 may be acquired by a portion provided outside of the automotive display system 10 and supplied to the image data generation unit 130.

A control unit 250 is further provided in this specific example. The control unit 250 adjusts at least one of a projection area 114a and a projection position 114 of the light flux 112 based on the position of the one eye 101 of the image viewer 100 detected by the position detection unit 210 by controlling the image projection unit 115.

The control unit 250 in this specific example controls the projection position 114 by, for example, controlling the drive unit 126a linked to the mirror 126 forming a portion of the projection unit 120 to control the angle of the mirror 126.

The control unit 250 can control the projection area 114a by, for example, controlling the various optical components forming the projection unit 120.

Thereby, it is possible to control the presentation position of the image to follow the head 105 of the image viewer 100 even in the case where the head 105 moves. The head 105 of the image viewer 100 does not move out of the image presentation position, and the practical viewing area can be increased.

The control unit 250 may adjust the luminance, contrast, etc., of the image by, for example, controlling the image formation unit 110.

Although the control unit 250 automatically adjusts at least one of the projection area 114a and the projection position 114 of the light flux 112 based on the detected position of the one eye 101 in the specific example recited above, the invention is not limited thereto. For example, the at least one of the projection area 114a and the projection position 114 of the light flux 112 may be manually adjusted based on the detected position of the one eye 101. In such a case, for example, the angle of the mirror 126 may be controlled by manually controlling the drive unit 126a while viewing the image of the head 105 of the image viewer 100 captured by the projection unit 120 on some display.

Thus, the automotive display system 10 according to this embodiment is a monocular display system. The frontward information acquisition unit 410 is provided, and a virtual leading vehicle image including a position corresponding to the frontward information can thereby be generated. In other words, as described below, the virtual leading vehicle image can be generated and disposed at the desired depth position corresponding to the road of the frontward path.

The projection toward the one eye of the image viewer is performed based on the detected position of the one eye. Thereby, the virtual leading vehicle image can be perceived with high positional precision at any depth position, and an automotive display system can be provided to perform a display easily viewable by the driver.

In regard to the aforementioned, although the image data generation unit 130 generates data relating to the image including the virtual leading vehicle image based on the frontward information acquired by the frontward information acquisition unit 410 and the detected position of the one eye 101 of the image viewer 100, the virtual leading vehicle image may be generated based on the frontward information acquired by the frontward information acquisition unit 410 in the case where the position of the one eye 101 does not substantially vary. In such a case as well, the virtual leading vehicle image can be displayed at any depth position, and an automotive display system can be provided to perform a display easily viewable by the driver.

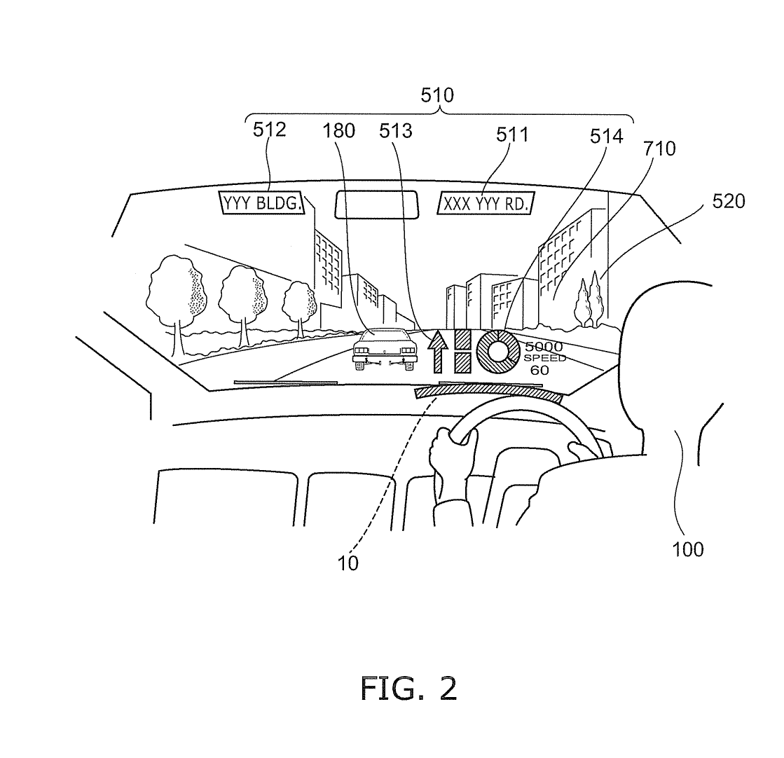

FIG. 2 is a schematic view illustrating the operating state of the automotive display system according to the first embodiment of the invention.

In the automotive display system 10 according to this embodiment illustrated in FIG. 2, a display image 510 including at least a virtual leading vehicle image 180 is displayed by projecting onto the reflector 711 (not illustrated) of the windshield 710. Thereby, the driver (the image viewer) 100 can simultaneously see an external environment image 520 and the display image 510. Thus, the automotive display system 10 can be used as an automotive HUD. In addition to the virtual leading vehicle image 180, the display image 510 may include, for example, a current position 511, surrounding building information 512, a path display arrow 513, vehicle information 514 such as speed, fuel, etc., and the like.

HUDs can superimpose a display on a background (the external environment image 520) and therefore provide an advantage that the driver (the image viewer 100) can intuitively understand the display. In particular, a monocular HUD allows the driver to simultaneously view the HUD display even when the fixation point of the driver is distal and therefore is suitable for displays superimposed on the external environment.

In the automotive display system 10 according to this embodiment, the virtual leading vehicle image 180 is generated at a position corresponding to frontward information acquired by the frontward information acquisition unit 410. At this time, the frontward information acquired by the frontward information acquisition unit 410 includes a width of at least one of a passable horizontal direction and a passable perpendicular direction of the road where the vehicle 730 is estimated to travel.

Here, the road where the vehicle 730 is estimated to travel refers to, for example, the frontward road in the travel direction of the road the vehicle 730 is currently traveling. For the vehicle 730 in a stopped state, for example, the frontward road in the direction from the rear of the vehicle body toward the front is referred to. In the case such as where, for example, the route where the vehicle 730 travels is determined by a navigation system and the like, the road of the frontward path based on the route is referred to. Further, “road” may be any location the vehicle 730 enters and may include spaces disposed between obstacles of garages and parking lots in addition to streets and the like. “Frontward path of the vehicle 730” refers to the frontward direction of the vehicle 730 when the vehicle 730 is traveling frontward and refers to the rearward direction of movement when the vehicle 730 is traveling rearward. To simplify the description, the case will now be described where the “road” is a street and the like and the vehicle 730 is traveling frontward. “Road estimated to be traveled” also may be simply referred to as “traveled road” or “road of travel.”

First, to simplify the description, the case will be described where a width in a passable horizontal direction (hereinbelow simply referred to as “width”) is taken as the frontward information.

“Passable width of the frontward road” refers to, for example, a road width. In the case where an obstacle such as a stopped or parked vehicle, various disposed objects, etc., exist in the road, the width of the road excluding the width of the obstacle is referred to. In the case where an oncoming vehicle is traveling opposite the travel direction of the vehicle 730, the width of the road excluding the width of the oncoming vehicle is referred to. In the case where a leading vehicle traveling at a traveling speed slower than the traveling speed of the vehicle 730 is within a constant distance, the width of the road excluding the width of the leading vehicle is referred to. Thus, the passable width of the frontward road can be taken as the passable width of the road excluding objects that obstruct the travel of the vehicle 730. In the case where the road of travel is a road having an opposite lane, the opposite lane is taken as an impassable road, and the passable width of the road is taken as the width of the lane of travel of the road excluding the width of the opposite lane.

First, to simplify the description, the case will be described where no obstacles such as oncoming vehicles and the like exist. In other words, the passable width of the frontward road is the road width. However, “road width” referred to hereinbelow is expanded to “passable width of the frontward road” in the case where an obstacle and the like such as an oncoming vehicle, etc., exist.

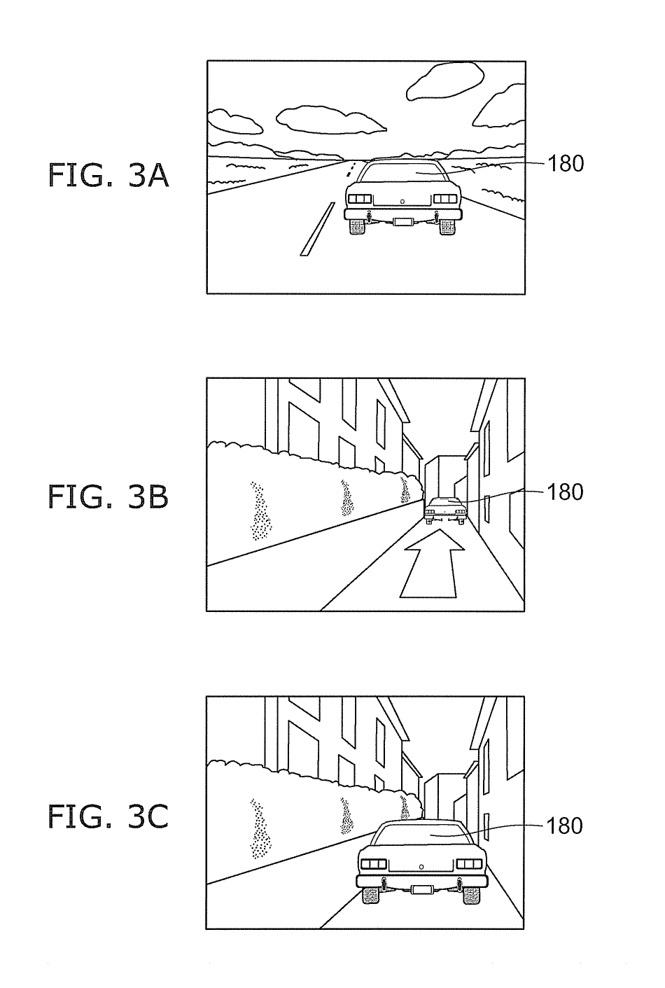

FIGS. 3A to 3C are schematic views illustrating operations of the automotive display system according to the first embodiment of the invention.

Namely, FIGS. 3A to 3C illustrate operations of the automotive display system in three different states.

In the case where the road width is not less than the predetermined first width as illustrated in FIG. 3A, the virtual leading vehicle image 180 is disposed at the predetermined depth set position.

Here, the first width is set to a width sufficiently wider than the width of the vehicle 730, that is, a width such that the driver can travel without driving outside of the road during travel, contacting a boundary of the road such as a guardrail, ditch, curb, etc., or feeling a sense of danger when passing an oncoming vehicle even when the driver operates the vehicle 730 without special attention.

For example, the first width may be set to a value of 2 m added to the width of the vehicle 730. In other words, in the case where the vehicle 730 travels on a road having a road width including 1 m of ample space on the left and right of the vehicle 730, the driver can travel safely and without feeling a sense of danger even when the driver operates the vehicle 730 without special attention.

The first width may be changed based on the traveling speed of the vehicle 730. In other words, the first width may be set wider for high traveling speeds of the vehicle 730 than for low traveling speeds. Because the risk increases and the driver feels a greater psychological burden when the traveling speed is high, travel support can be provided more effectively by thus changing the first width according to the traveling speed of the vehicle 730.

The first width may be changed not only based on the traveling speed of the vehicle 730 but also based on the weight of the vehicle 730 changing with the number of passengers, the loaded baggage, and the like of the vehicle 730, the brightness around the vehicle 730, the grade of the road of travel, the air temperature and weather around the vehicle 730, etc. Namely, the handling of the vehicle 730 and the risk change according to the weight thereof and the brightness therearound; the stopping distance of an automobile and the like changes with the grade of the road; and the ease of slippage on the street changes with the air temperature, the weather, etc., therearound. Therefore, safer and more convenient travel support can be performed by considering these factors to change the first width. The first width also may have any setting based on the proficiency and/or the preference of the driver and may be selected from several alternatives. Because the attentiveness of the driver changes with the continuous traveling time, the steering wheel operation frequency, and the like, the first width may be changed based on operating conditions such as the continuous traveling time, the operation frequency of the steering wheel, and the like.

In regard to the aforementioned, the predetermined depth set position may be determined based on the stopping distance of each vehicle in which the automotive display system is mounted. As described below, the stopping distance is the distance for an automobile and the like to stop from when a phenomenon requiring a stop is recognized to when the automobile and the like stop. For example, it is relatively safe when the distance from the vehicle 730 to a vehicle traveling the frontward path is longer than the stopping distance. In other words, the depth set position may be based on the stopping distance for a safe stop, e.g., a position more distal than the stopping distance by a determined value added to provide a margin.

Thereby, the vehicle 730 can be safely traveled to the depth position where the virtual leading vehicle image 180 is displayed without operating with particularly remarkable attentiveness.

In the case where an actual leading vehicle exists on the proximal side of the depth position where the virtual leading vehicle image 180 is displayed, the distance to the actual leading vehicle of the frontward path is too short, the driver can easily recognize the danger of this state, and travel support having improved safety can be provided.

Thus, in the case where the vehicle 730 travels on a road sufficiently wider than the width of the vehicle 730, the virtual leading vehicle image 180 is disposed at, for example, the depth set position predetermined based on the stopping distance and the like; attention thereby can be aroused in regard to the distance from the vehicle 730 to the leading vehicle of the frontward path; and support can be provided for safe traveling.

In the case where an actual leading vehicle exists on the proximal side of the depth position where the virtual leading vehicle image 180 is displayed, in addition to the aforementioned, it is possible to cause the virtual leading vehicle image 180 to flash, change the color of the display, display a combination of other figures, messages, etc., or simultaneously arouse attention by using a voice and the like.

As recited above, the case where the virtual leading vehicle image 180 is fixedly disposed at the depth set position is hereinbelow referred to as “relatively fixed distance disposition.” In other words, the virtual leading vehicle image 180 is disposed at the depth set position which is at a fixed relative distance from the vehicle 730. The virtual leading vehicle image 180 is displayed at a relatively fixed distance from the vehicle 730 while the vehicle 730 moves. Therefore, the scenery of the frontward path corresponding to the position where the virtual leading vehicle image 180 is disposed moves progressively frontward in response to the movement of the vehicle 730.

In the case where the road width is narrower (less) than the first width recited above and not less than a predetermined second width narrower than the first width as illustrated in FIG. 313, the virtual leading vehicle image 180 may be disposed at a position more distal than the depth set position. Here, the second width may be taken as the sum of the width of the vehicle 730 and a predetermined margin. For example, the second width may be a passable width when the vehicle 730 travels while moving slowly. In other words, the driver can be informed that the road is passable by disposing the virtual leading vehicle image 180 at a position more distal than the depth set position in the case where the road width is passable by moving slowly while paying attention.

At this time, the virtual leading vehicle image 180 may be disposed more distally than the depth set position by disposing the virtual leading vehicle image 180 to move away as viewed from the vehicle 730. In other words, although the virtual leading vehicle image 180 is initially disposed, for example, at the depth set position, in the case where a road having a road width passable by moving slowly is approached, the driver can be informed naturally and congruously that the road is passable by disposing the virtual leading vehicle image 180 to move away from the depth set position as if accelerating away from the vehicle 730.

In such a case, the virtual leading vehicle image 180 may be disposed to move away from the depth set position, and then after moving a predetermined distance, may be once again disposed at the depth set position. In other words, in the case where a road having a road width passable by moving slowly is approached, the virtual leading vehicle image 180 may be disposed to move as if accelerating away from the vehicle 730; and after moving a certain distance away, the virtual leading vehicle image 180 is disposed to return once again to the initial depth set position. For example, the virtual leading vehicle image 180 is moved away as if accelerating, and after moving away a predetermined distance of, for example, 5 m to 100 m, returns to the initial depth set position. Thereby, the driver can be informed naturally and congruously that the road is passable.

In regard to the aforementioned, the speed at which the virtual leading vehicle image 180 moves away may be changed based on the difference between the road width and the second width. In other words, when conditions are informed to the driver, for example, in the case where the road width is relatively close to the second width and should be traveled by reducing the speed and moving sufficiently slowly, the speed at which the virtual leading vehicle image 180 moves away may be low; and in the case where the road width is wider than the second width by a certain width and the safety does not easily decline even when the speed is not reduced very much, the speed at which the virtual leading vehicle image 180 moves away may be increased.

In the case where an intersection and the like, where the direction the vehicle 730 should travel may change, exists at a distance shorter than the predetermined distance recited above, the virtual leading vehicle image 180 may be disposed to move away to the position at the shorter distance and then return to the set depth distance. Thereby, the driver can be prevented from recognizing the wrong direction for the vehicle 730 to travel.

In such a case, in addition to the aforementioned, it is possible to change the display state of the virtual leading vehicle image 180 displayed moving away, display a combination of other figures, messages, etc., or simultaneously provide guidance by a voice and the like.

The disposition of the virtual leading vehicle image 180 to move away as viewed from the position of the vehicle 730 as recited above is hereinbelow referred to as “depthward moving disposition.” The virtual leading vehicle image 180 is displayed to move away as viewed from the vehicle 730 while the vehicle 730 is moving and therefore is recognized to move frontward at a speed higher than the movement speed of the vehicle 730.

On the other hand, in the case where the road width is narrower than the second width recited above as illustrated in FIG. 3C, the virtual leading vehicle image 180 is disposed at a position based on a position where the road is narrower than the second width recited above. In other words, in the case where the road width is impassable even when the vehicle 730 moves slowly, it is informed to the driver that the road is impassable. At this time, the virtual leading vehicle image 180 may be disposed, for example, at a prescribed position more proximal than where the road width becomes narrower than the second width. The driver can thereby be informed of this condition beforehand. In the case where the road width is impassable even when the vehicle 730 moves slowly, in addition to the aforementioned, it is possible to cause the virtual leading vehicle image 180 to flash, change the color of the display, display a combination of other figures, messages, etc., or simultaneously arouse attention by using a voice and the like.

The disposition of the virtual leading vehicle image 180 is hereinbelow referred to as “absolutely fixed position” when the virtual leading vehicle image 180 is disposed as recited above at a designated position in the road, i.e., the frontward information, regardless of the position of the vehicle 730 and the depth set position. In such a case, the virtual leading vehicle image 180 is fixedly disposed at a designated position of the road while the vehicle 730 travels frontward. Therefore, the virtual leading vehicle image 180 appears to gradually move closer as viewed from the vehicle 730. The traveling speed of the vehicle 730 often is relatively low in the case where absolutely fixed disposition is performed. Therefore, the virtual leading vehicle image 180 appears to move closer relatively moderately.

Thus, according to the automotive display system 10 according to this embodiment, travel support is possible to arouse attention particularly in regard to the frontward distance between vehicles in the case where the road width is sufficiently wider than the vehicle 730, and travel support can be performed to inform in the case where the road width is passable when moving slowly and in the case where the road width is too narrow to be passable.

In regard to the aforementioned, the frontward information acquired by the frontward information acquisition unit 410 is frontward information relating to the road of travel of the vehicle 730. In other words, the frontward information is acquired based on the route where the vehicle 730 is conjectured to travel.

For example, the route where the vehicle 730 travels may be determined by a navigation system and the like, and the travel route thereof may be estimated to be where the vehicle 730 will travel. In the case where, for example, an intersection or a branch point is approached in the road being traveled, the frontward information of the road of the route where the vehicle 730 is estimated to travel may be acquired, the road width may be determined as recited above, and the virtual leading vehicle image 180 may be generated based thereon. The virtual leading vehicle image 180 may be disposed at the depth position recited above while corresponding to the configuration (the curving state, etc.) of the road of the route conjectured to be traveled. The route where the vehicle 730 is conjectured to travel is described below.

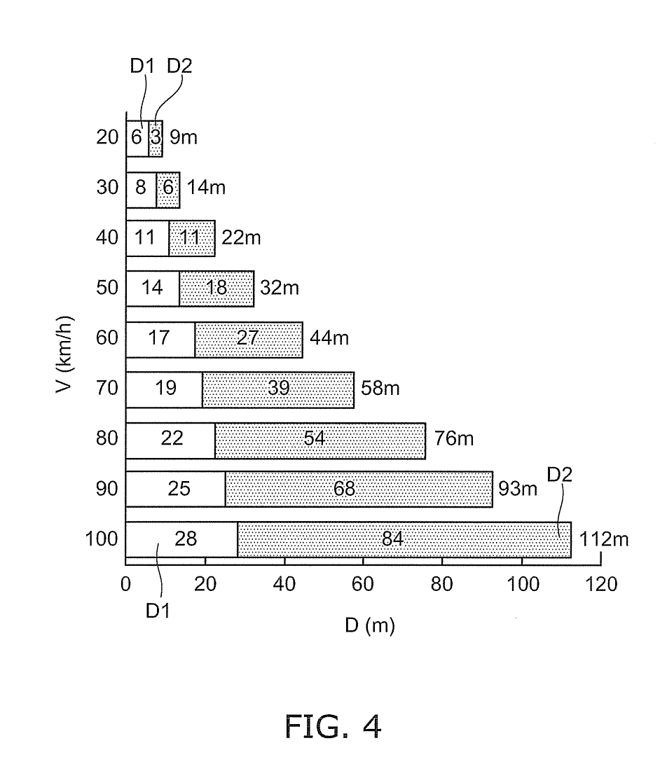

FIG. 4 is a schematic view illustrating the stopping distance of the vehicle according to the travel support of the automotive display system according to the first embodiment of the invention.

Namely, FIG. 4 illustrates the stopping distance of an automobile as one example.

As illustrated in FIG. 4, a traveling speed V of the vehicle changes with a stopping distance D. Here, the stopping distance D is the distance from where the driver recognizes a phenomenon requiring a stop to where the automobile and the like stop. The stopping distance D is the total of an idle running distance D1 and a braking distance D2, where the idle running distance D1 is the distance the automobile and the like move from where the driver recognizes the phenomenon requiring a stop to where the brake is stepped on and the brake starts to work, and the braking distance D2 is the distance from where the brake starts to work to where the automobile and the like stop.

For example, the stopping distance D is 32 m when the vehicle 730 is traveling at 50 km/h. In such a case, the depth set position may be determined based on a stopping position of 32 m. For example, the depth set position may be taken as, for example, 40 m frontward of the vehicle 730 by adding a certain margin, e.g., a value from multiplying by a coefficient and/or a certain number, to 32 m. The margin may be determined to account for, for example, a time lag from when the phenomenon requiring a stop occurs to when the driver recognizes the same and other various conditions such as conditions of the vehicle, the driver, and surrounding conditions.

Accordingly, as described in regard to FIG. 3A, in the case where the road width is not less than the predetermined first width, the virtual leading vehicle image 180 may be disposed at the frontward position of 40 m, i.e., the predetermined depth set position.

Here, the stopping distances illustrated in FIG. 4 represent one example, and the stopping distances change according to the vehicle in which the automotive display system 10 according to this embodiment is mounted. Therefore, the set depth position may be set based on the stopping distance of the vehicle in which the automotive display system 10 is mounted. The set depth distance may be changed based on, for example, the weight of the vehicle 730, the brightness around the vehicle 730, the grade of the road of travel, the air temperature and weather around the vehicle 730, etc. Namely, the handling of the vehicle 730 and the risk change according to the weight of the vehicle 730 and the brightness therearound; the stopping distance of an automobile and the like change with the grade of the road; and the ease of slippage on the street changes with the air temperature, the weather, etc., around the vehicle 730. Therefore, safer and more convenient travel support can be performed by considering these factors to change the set depth distance. The set depth distance also may have any setting based on the proficiency and/or the preference of the driver and may be selected from several alternatives. Because the attentiveness of the driver changes with continuous traveling time, the operation frequency of the steering wheel and the like, etc., the set depth distance may be changed based on operating conditions such as the continuous traveling time and the operation frequency of the steering wheel operation and the like.

Thus, in the automotive display system 10 according to this embodiment, the virtual leading vehicle image 180 is disposed at various depth positions in the frontward information. In other words, the virtual leading vehicle image 180 is disposed at the depth set position recited above in the case where the road width is sufficiently wide; the virtual leading vehicle image 180 is disposed, for example, to move away to a position more distal than the depth set position in the case where the road is passable when moving slowly; and the virtual leading vehicle image 180 is disposed at the position of an impassable road width in the case where the road width is impassable.

The display control is performed similarly in the case where, for example, an oncoming vehicle is detected. For example, in the case of a road where passing is not problematic, the virtual leading vehicle image 180 is disposed at the depth set position and is positioned to maintain a constant distance frontward of the vehicle 730 as viewed from the vehicle 730. In the case where it is predicted that it is difficult but possible for vehicles to pass each other, a depthward moving disposition may be performed on the display position of the virtual leading vehicle image 180 such that the virtual leading vehicle image 180 is perceived as if traveling while increasing speed; the driver is informed that the oncoming vehicle can be passed; and thereafter, the virtual leading vehicle image 180 is perceived to reduce speed to return to the initial vehicle spacing. In the case where it is determined that the vehicles cannot pass each other, the virtual leading vehicle image 180 is displayed at its location and is perceived as if the virtual leading vehicle image 180 is stopped at its location.

A similar operation may be performed in the case where the road of travel includes obstacles such as parked vehicles, buildings, disposed objects, and detour signs, for example, of road construction and the like.

Thus, the automotive display system 10 according to this embodiment can perform safe, convenient, and easily viewable travel support.

Although methods for changing the disposition of the virtual leading vehicle image 180 based on the frontward road width (i.e., the width in the horizontal direction) are described in regard to the aforementioned, it is possible to implement a similar operation for a passable width in the perpendicular direction of the frontward road. In other words, in the case where an obstacle and the like such as a railway or another intersecting street exist above the road of travel, the virtual leading vehicle image 180 can be displayed by determining the ease of passing of the vehicle 730 based on the first width recited above (in this case, a first height) and the second width recited above (in this case, a second height).

For example, in the case where another object exists at a sufficiently high position such as a three dimensionally intersecting street or pedestrian overpass, that is, when the passable width in the perpendicular direction of the frontward road is not less than the first width, the virtual leading vehicle image 180 may be disposed at the depth set position recited above. In the case where another street is provided to intersect at a relatively low position but is passable by moving slowly, that is, the height is lower than the first width but not less than the second width, the virtual leading vehicle image 180 may be disposed, for example, to move away to a position more distal than the depth set position. In the case where the height is lower than the second width and is impassable, the virtual leading vehicle image 180 is disposed at a position based on a position of the impassable height.

Thereby, the safety can be improved and a more convenient travel support can be provided.

In regard to the aforementioned, the first width and the second width in the horizontal direction and the first width and the second width in the perpendicular direction may have values different from each other.

The displayed size of the virtual leading vehicle image 180 has a size at each display position such that the driver recognizes a vehicle at each position having the same size as the vehicle 730. In other words, the virtual leading vehicle image 180 is generated at the same size as when the vehicle 730 is perceived to exist at the depth position where the virtual leading vehicle image 180 is generated in the scenery of the frontward path when viewed by the image viewer 100. Thereby, the driver can more naturally and congruously recognize the virtual leading vehicle image 180 and can recognize to compare the road width of the frontward path to the vehicle 730. Also, the depth position at which the virtual leading vehicle image 180 is disposed can be recognized more accurately by the effect of the apparent size of the virtual leading vehicle image 180 becoming smaller as the depth position moves away.

Although the case where the vehicle 730 travels frontward on a road is described above, a similar operation can be performed not only for roads but also in the case where an obstacle exists in a garage, parking lot, and the like. For example, it can be informed whether or not the vehicle 730 can pass through a space defined between obstacles by accordingly changing the disposition of the virtual leading vehicle image 180. The display is possible also in directions other than frontward of the vehicle 730. For example, the virtual leading vehicle image 180 may be generated to inform the driver whether or not widths are passable based on the passable width of a road, garage, etc., when the vehicle 730 is traveling rearward.

Characteristics of a human relating to the perception of the depth position will now be described.

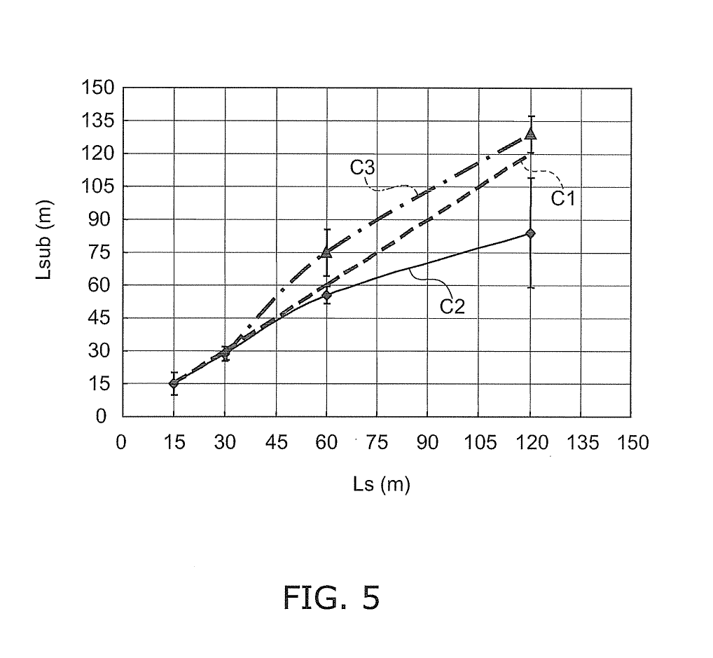

FIG. 5 is a graph illustrating the characteristics of the automotive display system according to the first embodiment of the invention.

Namely, FIG. 5 illustrates experimental results of a subjective depth distance Lsub perceived by a human when the virtual leading vehicle image 180 was displayed at a changing set depth distance Ls using the automotive display system 10 according to this embodiment. The set depth distance Ls is plotted on the horizontal axis and the subjective depth distance Lsub is plotted on the vertical axis.

The broken line C1 is the characteristic when the subjective depth distance Lsub matches the set depth distance Ls.

The solid line C2 illustrates the characteristic of the subjective depth distance Lsub actually observed in the case where the distance between the virtual leading vehicle image 180 and the image viewer is fixed at the set depth distance Ls. In other words, the solid line C2 is the characteristic for the relatively fixed distance disposition.

On the other hand, the single dot-dash line C3 illustrates the characteristic of the subjective depth distance Lsub actually observed in the case where the distance between the virtual leading vehicle image 180 and the image viewer is increased such that the virtual leading vehicle image 180 moves away at a rate of 20 km/h. In other words, the single dot-dash line C3 is the characteristic for the depthward moving disposition.

In this experiment, the position and the size of the virtual leading vehicle image 180 in the image were changed according to the set depth distance Ls.

In the case of the relatively fixed distance disposition where the distance between the virtual leading vehicle image 180 and the image viewer is fixed at the set depth distance Ls as illustrated in FIG. 5, the solid line C2 substantially matches the broken line C1 and the subjective depth distance Lsub matches the set depth distance Ls when the set depth distance Ls is short. However, as the set depth distance Ls lengthens, the solid line C2 takes on smaller values than the broken line C1.

Specifically, although the subjective depth distance Lsub matches the set depth distance Ls at set depth distances Ls of 15 m and 30 m, the subjective depth distance Lsub is shorter than the set depth distance Ls at 60 m and 120 m. The difference between the subjective depth distance Lsub and the set depth distance Ls increases as the set depth distance Ls lengthens.

The following formula (1) is obtained by approximating the solid line C2 (the characteristic of the subjective depth distance Lsub) by a quadratic curve.

Ls=0.0037×(Lsub)²+1.14×(Lsub) (1)

Accordingly, the characteristic of the solid line C2 based on formula (1) is such that the subjective depth distance Lsub matches the set depth distance Ls when the set depth distance Ls is shorter than 45 m, while the subjective depth distance Lsub is shorter than the set depth distance Ls when the set depth distance Ls is 45 m or longer.

The subjective depth distance Lsub, including fluctuations, is shorter than the set depth distance Ls for a set depth distance Ls of 60 m and longer.

On the other hand, in the case of the “depthward moving disposition” where the virtual leading vehicle image 180 moves away from the image viewer such that the distance therebetween increases, the single dot-dash line C3 substantially matches the broken line C1 and the subjective depth distance Lsub matches the set depth distance Ls when the set depth distance Ls is short, while the single dot-dash line C3 takes on values slightly larger than the broken line C1 as the set depth distance Ls lengthens.

Specifically, although the subjective depth distance Lsub matches the set depth distance Ls at the set depth distances Ls of 15 m and 30 m, the subjective depth distance Lsub is slightly longer than the set depth distance Ls at 60 m and 120 m. At 60 m and 120 m, the difference between the subjective depth distance Lsub and the set depth distance Ls is substantially constant, and the subjective depth distance Lsub is about 8 m to 15 m longer than the set depth distance Ls.

However, compared to the case of the “relatively fixed distance disposition” illustrated by the solid line C2, it can be said that the subjective depth distance Lsub matches the set depth distance Ls relatively well for the “depthward moving disposition” illustrated by the single dot-dash line C3. In the monocular HUD, the perceived depth position of the displayed object (here, the virtual leading vehicle image 180) greatly depends on the position of the matched overlay on the background; and the error of the perceived depth position increases as the position shifts as in the case of the “relatively fixed distance disposition”. As in the case of the “depthward moving disposition”, the depth position is more easily perceived when the displayed image is moving, and the perceived depth position error is reduced.

The characteristics illustrated in FIG. 5 represent a phenomenon discovered for the first time in these experiments. The disposition of the virtual leading vehicle image 180 of the invention can be performed based on this phenomenon. Namely, the virtual leading vehicle image 180 can be disposed at a more accurate depth position by displaying with a corrected difference between the subjective depth distance Lsub and the set depth distance Ls in the range of the set depth distance Ls where the subjective depth distance Lsub does not match the set depth distance Ls.

In other words, in the case where the “relatively fixed distance disposition” is performed in the automotive display system 10 according to this embodiment, the “relatively fixed distance disposition” may be performed as follows.

For example, in the case where the distance from the depth set position to the vehicle 730 is shorter than a preset distance, a depth target position where the virtual leading vehicle image 180 is disposed (generated) matches the depth set position where the virtual leading vehicle image 180 is disposed (generated) in the scenery of the frontward path.

In the case where the distance from the depth set position to the vehicle 730 is equal to the preset distance or longer, the depth target position where the virtual leading vehicle image 180 is disposed (generated) is more distal than the depth position where the virtual leading vehicle image 180 is disposed (generated) in the scenery of the frontward path as viewed by the image viewer 100.

In other words, in the case where the distance from the depth set position to the vehicle 730 is equal to the preset distance or longer, the depth target position is corrected to a position more distal than the depth position in the scenery of the frontward path corresponding to the virtual leading vehicle image 180 in the image, and the virtual leading vehicle image 180 is disposed (generated) at the corrected depth target position.

In regard to the aforementioned, either 45 m or 60 m may be used as the preset distance. At a distance of 45 m, the subjective depth distance Lsub starts to become shorter than the set depth distance Ls. In the case where 45 m is used as the preset distance, the subjective depth distance Lsub matches the set depth distance Ls with good precision. On the other hand, at a distance of 60 m, the subjective depth distance Lsub (including fluctuations) starts to become substantially shorter than the set depth distance Ls. In the case where 60 m is used as the preset distance, the subjective depth distance Lsub matches the set depth distance Ls with substantially no problems.

Here, the virtual leading vehicle image 180 can be displayed by correcting the set depth distance Ls (i.e., the depth target position) such that the subjective depth distance Lsub matches the set depth distance Ls based on the characteristic of formula (1). For example, in the case where a subjective depth distance Lsub of 90 m is desired, according to formula (1), the depth set position Ls (i.e., the depth target position) is corrected to 133 m and the virtual leading vehicle image 180 is displayed.

In addition to 45 m and 60 m, the preset distance recited above may be, for example, between 40 m and 60 m, e.g., 50 m, or in some cases longer than 60 m based on preferences of the image viewer 100 and/or the specifications of the vehicle 730 in which the automotive display system 10 is mounted.

The extent of the correction processing recited above around the preset distance may be performed not discontinuously but continuously to satisfy, for example, formula (1). Although the characteristic of the solid line C2 is expressed as a quadratic function in formula (1), other functions may be used. In other words, for a distance longer than the preset distance, it is sufficient that the set depth distance Ls, that is, the depth target position, is corrected to correct the characteristic of the solid line C2 to match the subjective depth distance Lsub; and any appropriate function may be used during the correction processing.

On the other hand, in the case where the “depthward moving disposition” is performed in the automotive display system 10 according to this embodiment, the “depthward moving disposition” may be performed as follows.

For example, in the case where the distance from the depth set position to the vehicle 730 is shorter than a preset distance, the depth target position where the virtual leading vehicle image 180 is disposed (generated) matches the depth set position where the virtual leading vehicle image 180 is disposed (generated) in the scenery of the frontward path.

In the case where the distance from the depth set position to the vehicle 730 is equal to the preset distance or longer, the depth target position where the virtual leading vehicle image 180 is disposed (generated) is more proximal than the depth position where the virtual leading vehicle image 180 is disposed (generated) in the scenery of the frontward path as viewed by the image viewer 100.

In other words, in the case where the distance from the depth set position to the vehicle 730 is equal to the preset distance or longer, the depth target position is corrected to a position more proximal than the depth position in the scenery of the frontward path corresponding to the virtual leading vehicle image 180 in the image, and the virtual leading vehicle image 180 is disposed (generated) at the corrected depth target position.

In regard to the aforementioned, either 30 m or 60 m may be used as the preset distance. At a distance of 30 m, the subjective depth distance Lsub starts to become longer than the set depth distance Ls. In the case where 30 m is used as the preset distance, the subjective depth distance Lsub matches the set depth distance Ls with good precision. On the other hand, at a distance of 60 m, the subjective depth distance Lsub (including fluctuations) starts to become substantially longer than the set depth distance Ls. In the case where 60 m is used as the preset distance, the subjective depth distance Lsub matches the set depth distance Ls with substantially no problems.

Here, the virtual leading vehicle image 180 can be displayed by correcting the set depth distance Ls (i.e., the depth target position) such that the subjective depth distance Lsub matches the set depth distance Ls based on the characteristic of the single dot-dash line C3. For example, in the case where a subjective depth distance Lsub of 90 m is desired, according to the characteristic of the single dot-dash line C3, the depth set position Ls (i.e., the depth target position) is corrected to 75 m and the virtual leading vehicle image 180 is displayed.

However, in the case of the “depthward moving disposition” as described above, the difference between the subjective depth distance Lsub and the set depth distance Ls is not very large. Therefore, the depth target position where the virtual leading vehicle image 180 is disposed may be matched to the depth set position in the frontward information regardless of the distance from the depth set position to the vehicle 730.

Thus, it is possible to perceive a more accurate depth position by disposing the virtual leading vehicle image 180 corrected based on the characteristics relating to the depth perception of a human clarified for the first time herein.

A method for disposing the virtual leading vehicle image 180 at the depth position will now be described.

In a monocular HUD, a depth cue by binocular parallax is not provided, and the depth position of the virtual leading vehicle image 180 appears indistinct to the image viewer 100. Therefore, it is difficult to designate the depth position of the virtual leading vehicle image 180.

The inventors investigated effective depth cues usable for monocular vision. As a result, it was discovered that relative “positions” between the position of the virtual leading vehicle image 180 and the background position greatly affect the depth perception in a monocular vision HUD. In other words, by controlling the relative “positions” between the position of the virtual leading vehicle image 180 and the background position, the depth position can be recognized with good precision. Additionally, the depth position can be controlled by using the “size” that changes with the depth position and/or “motion parallax”.

The method for disposing the depth position of the virtual leading vehicle image 180 by using the “position” recited above will now be described in detail. In other words, the control of the “position” recited above in the display image corresponding to a change of the set depth distance Ls will be described.

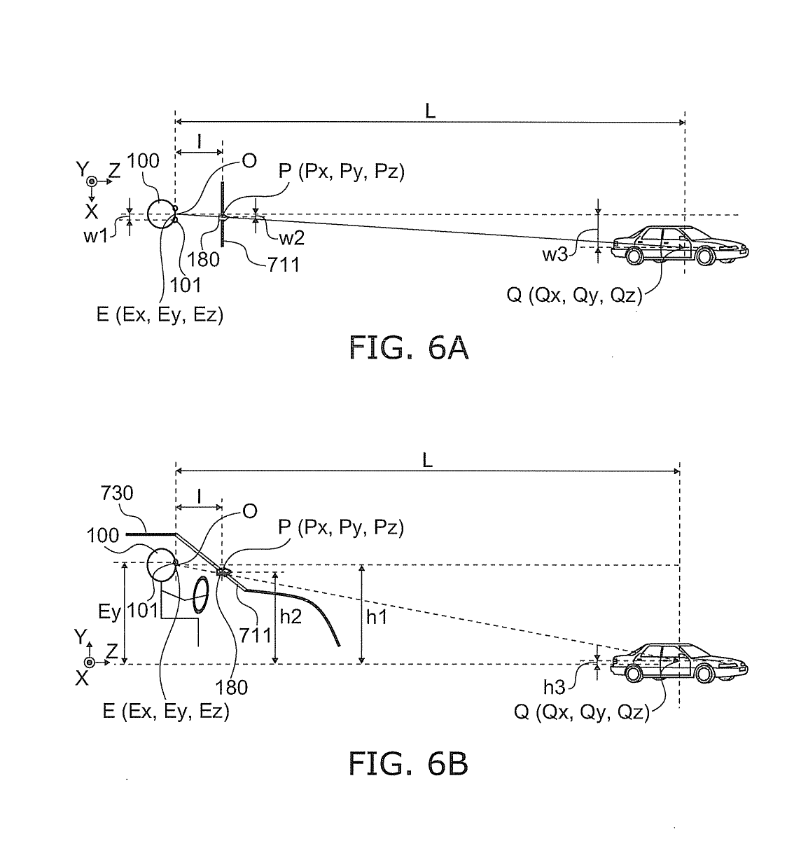

FIGS. 6A and 6B are schematic views illustrating a coordinate system of the automotive display system according to the first embodiment of the invention.

Namely, FIG. 6A is a schematic view from above the head of the image viewer 100. FIG. 6B is a schematic view from the side of the image viewer 100.

Here, as illustrated in FIGS. 6A and 6B, a three dimensional orthogonal coordinate system is used as one example. Namely, the direction perpendicular to the ground surface is taken as a Y axis, the travel direction of the vehicle 730 is taken as a Z axis, and an axis orthogonal to the Y axis and the Z axis is taken as an X axis. As viewed by the image viewer 100, the upward direction is the Y axis direction, the travel direction is the Z axis direction, and the left and right direction is the X axis direction.

Here, a position of the one eye 101 of the image viewer 100 used for viewing (for example, the dominant eye, e.g., the right eye) is taken as a position E of the one eye (Ex, Ey, Ez).

A position where the reflector 711 of the vehicle 730 reflects the virtual leading vehicle image 180 formed by the automotive display system 10 according to this embodiment is taken as a virtual leading vehicle image position P (Px, Py, Pz). The virtual leading vehicle image position P may be taken as a reference position of the virtual leading vehicle image 180 and may be taken as, for example, the center and/or centroid of the virtual leading vehicle image 180.

Here, a prescribed reference position O (0, h1, 0) is determined. Here, the origin point of the coordinate axes is taken as a position (0, 0, 0) contacting the ground surface. In other words, the reference position O is positioned a height h1 above the origin point of the coordinate axis.

The position where a virtual image of the virtual leading vehicle image 180 is optically formed as viewed from the prescribed reference position O recited above is taken as a virtual image position Q (Qx, Qy, Qz).

As viewed from the reference position O, a shift amount w1 is the shift amount of the position E of the one eye in the X axis direction; a shift amount w2 is the shift amount of the virtual leading vehicle image position P in the X axis direction; and a shift amount w3 is the shift amount of the virtual image position Q in the X axis direction.

On the other hand, as viewed from the origin point of the coordinate axis, a shift amount Ey is the shift amount of the position E of the one eye in the Y axis direction. As viewed from the reference position O, the shift amount of the virtual leading vehicle image position P in the Y axis direction is (h1−h2), and the shift amount of the virtual image position Q in the Y axis direction is (h1−h3).

The distance between the reference position O and the virtual leading vehicle image position P in the Z axis direction is taken as a virtual leading vehicle image distance I. The distance between the reference position O and the virtual image position Q in the Z axis direction is taken as a virtual image distance L. The virtual image distance L corresponds to the set depth distance Ls.

During the disposition of the virtual leading vehicle image 180, the virtual image position Q becomes the depth target position, and the position at the set depth distance Ls as viewed from the reference position O becomes the depth target position.

Here, the change of the position E of the one eye (Ex, Ey, Ez) in the Z axis direction and the virtual leading vehicle image position P (Px, Py, Pz) in the Z axis direction are substantially small. Therefore, a description thereof is omitted, and the position E of the one eye (Ex, Ey) and the virtual leading vehicle image position P (Px, Py) are described. Namely, the disposition method of the virtual leading vehicle image position P (Px, Py) in the X-Y plane is described.

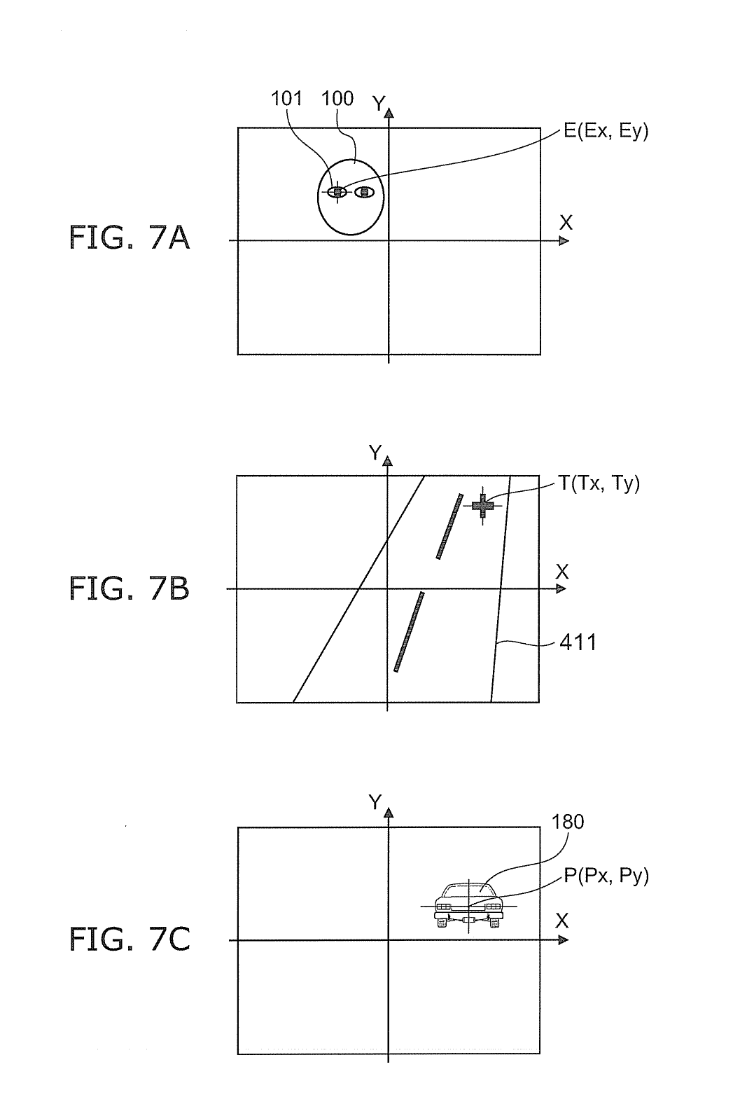

FIGS. 7A to 7C are schematic views illustrating coordinates of the automotive display system according to the first embodiment of the invention.

Namely, FIGS. 7A, 7b and 7C illustrate the position E of the one eye (Ex, Ey) recited above, a frontward display position T (Tx, Ty) described below, and the virtual leading vehicle image position P (Px, Py), respectively, in the X-Y plane.

FIG. 7A illustrates a captured image of the head 105 of the image viewer 100 captured by the imaging unit 211. As illustrated in FIG. 7A, the captured image undergoes image processing by the image processing unit 212. The position of the one eye 101 of the image viewer 100 is detected by a determination of the calculation unit 213. Thus, the position E of the one eye (Ex, Ey), i.e., the position of the one eye 101 as viewed from the reference position O, is detected by the position detection unit 210. In other words, Ex and Ey are calculated by the position detection unit 210.

FIG. 7B illustrates the frontward information acquired by the frontward information acquisition unit 410. The frontward information acquisition unit 410 acquires the frontward information such as the configurations of streets and intersections by, for example, reading pre-stored data relating to, for example, street conditions, frontward imaged data from the vehicle 730, and the like. In this specific example, frontward information such as the width and the configuration of the street, the distance from the vehicle 730 (the image viewer 100) to each position of the street, the ups and downs of the street, etc., are acquired.

As illustrated in FIG. 7B, a position corresponding to a position where the virtual leading vehicle image 180 is to be displayed in the frontward information is ascertained. For example, the position in the frontward information corresponding to the depth position where the virtual leading vehicle image 180 is to be displayed in the road of travel of the vehicle 730 is ascertained as the frontward display position T (Tx, Ty). Restated, Tx and Ty are ascertained. Such an operation may be performed by, for example, the image data generation unit 130.

FIG. 7C illustrates the virtual leading vehicle image position P (Px, Py), i.e., the position where the virtual leading vehicle image 180 is projected onto the reflector 711 of the vehicle 730 in the automotive display system 10. The virtual leading vehicle image position P (Px, Py) is determined based on the position E of the one eye (Ex, Ey) and the frontward display position T (Tx, Ty) recited above. Such an operation may be performed by, for example, the image data generation unit 130.

In other words, in the automotive display system 10 according to this embodiment, an image is generated and disposed at the virtual leading vehicle image position P (Px, Py) of the virtual leading vehicle image 180 based on the frontward display position T (Tx, Ty) based on the frontward information and the detected position of the one eye, i.e., the position E of the one eye (Ex, Ey). The light flux 112 including the image is projected toward the one eye 101 of the image viewer 100. Thereby, the virtual leading vehicle image 180 can be displayed at any depth position, and an automotive display system can be provided to perform a display easily viewable by the driver.

In regard to the aforementioned, the frontward display position T (Tx, Ty) can be matched to the virtual image position Q (Qx, Qy). However, as described in regard to FIG. 5, the frontward display position T (Tx, Ty) and the virtual image position Q (Qx, Qy) may be set differently to correct the characteristics of the solid line C2 and the single dot-dash line C3. First, a method for setting the virtual leading vehicle image position P (Px, Py) in which the frontward display position T (Tx, Ty) and the virtual image position Q (Qx, Qy) are set to match each other will be described.

In regard to the X axis direction illustrated in FIG. 6A, the ratio of the shift amount w3 of the frontward display position T (Tx, Ty), i.e., the virtual image position Q (Qx, Qy), in the X axis direction, to the shift amount w2 of the virtual leading vehicle image position P (Px, Py) in the X axis direction is the same as the ratio of the virtual image distance L to the virtual leading vehicle image distance I. Accordingly, in the case where the one eye 101 of the image viewer 100 is disposed at the reference position O, the value of the virtual leading vehicle image position P (Px, Py) in the X axis direction, i.e., the shift amount w2, is ascertained by w3×I/L. In the case where the one eye 101 of the image viewer 100 is shifted from the reference position O, it is sufficient to correct by the shift amount, i.e., the distance Ex (w1).

On the other hand, in regard to the Y axis direction illustrated in FIG. 6B, the ratio of the shift amount (h1−h3) of the frontward display position T (Tx, Ty), i.e., the virtual image position Q (Qx, Qy), in the Y axis direction to the shift amount (h1−h2) of the virtual leading vehicle image position P (Px, Py) in the Y axis direction is the same as the ratio of the virtual image distance L to the virtual leading vehicle image distance I. Accordingly, in the case where the one eye 101 of the image viewer 100 is disposed at the reference position O, the value of the virtual leading vehicle image position P (Px, Py) in the Y axis direction, i.e., the shift amount (h1−h2), is ascertained by (h1−h3)×I/L. In the case where the one eye 101 of the image viewer 100 is shifted from the reference position O, it is sufficient to correct by the shift amount, i.e., the distance (h1−Ey).

At this time, in addition to the virtual leading vehicle image position P (Px, Py), at least one of the tilt (α, β, and γ) and the size S of the virtual leading vehicle image 180 may be changed based on the disposition of the virtual leading vehicle image 180.

Thus, the virtual leading vehicle image 180 can be displayed at any frontward display position T (Tx, Ty), i.e., the virtual image position Q (Qx, Qy).

Based on the aforementioned, the virtual leading vehicle image 180 can be disposed with high precision at any depth position. In other words, at least one of the “relatively fixed distance disposition”, the “depthward moving disposition”, and the “absolutely fixed disposition” may be executed to increase the recognition precision of the depth position.

The frontward display position T (Tx, Ty) and the virtual image position Q (Qx, Qy) may be changed and set to correct the characteristics of the solid line C2 and the single dot-dash line C3 illustrated in FIG. 5, and the recognition precision of the depth position can be further increased.

For example, as described above, the relatively fixed disposition is performed in the case where the passable road width is not less than the predetermined first width. The operation at this time may be as follows.

In the case where the road width is not less than the first width and the distance from the vehicle 730 to the depth position where the virtual leading vehicle image 180 is generated in the scenery of the frontward path is shorter than the preset distance, the target position where the virtual leading vehicle image 180 is generated in the image is matched to the position in the image corresponding to the position where the virtual leading vehicle image 180 is generated in the scenery of the frontward path. Thereby, the virtual leading vehicle image 180 is disposed at the depth set position.

In the case where the distance from the vehicle 730 to the depth position where the virtual leading vehicle image 180 is generated in the scenery of the frontward path is equal to the preset distance or more, the target position where the virtual leading vehicle image 180 is generated in the image is disposed on the outer side of the position in the image corresponding to the position where the virtual leading vehicle image 180 is generated in the scenery of the frontward path as viewed from the center of the image. Thereby, the virtual leading vehicle image 180 is disposed more distally than the depth set position.

Thereby, the characteristics of the depth perception of the human are corrected for the “relatively fixed disposition”, and the depth can be perceived with high precision.

At this time, as described above, either 45 m or 60 m may be used as the predetermined distance recited above.

The “depthward moving disposition” recited above is performed in the case where the passable road width is narrower than the first width and not less than the second width. The operation at this time may be as follows.

In other words, the target position where the virtual leading vehicle image 180 is generated in the image is matched to the position in the image corresponding to the position where the virtual leading vehicle image 180 is generated in the scenery of the frontward path in the case where the passable road width is narrower than the first width, the passable road width is not less than the second width, and the distance from the vehicle 730 to the depth position where the virtual leading vehicle image 180 is generated in the scenery of the frontward path is shorter than the preset distance. Thereby, the virtual leading vehicle image 180 is disposed at the depth set position.

In the case where the distance from the vehicle 730 to the depth position where the virtual leading vehicle image 180 is generated in the scenery of the frontward path is equal to the preset distance or more, the target position where the virtual leading vehicle image 180 is generated in the image is disposed on the inner side of the position in the image corresponding to the position where the virtual leading vehicle image 180 is generated in the scenery of the frontward path as viewed from the center of the image. Thereby, the virtual leading vehicle image 180 is disposed more proximally than the depth set position as viewed by the image viewer 100.

Thereby, the characteristics of the depth perception of the human are corrected for the “depthward moving disposition”, and the depth can be perceived with high precision.

One example of the operation of the automotive display system 10 according to this embodiment described above will now be described using a flowchart.

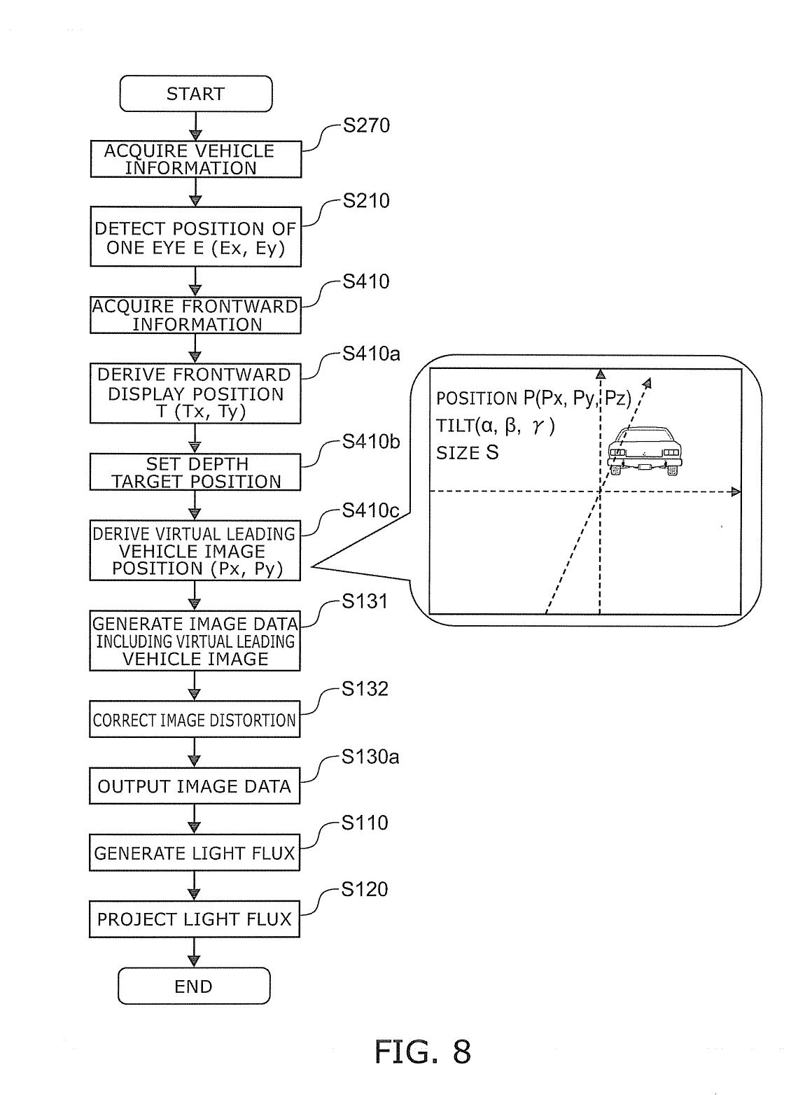

FIG. 8 is a flowchart illustrating the operation of the automotive display system according to the first embodiment of the invention.

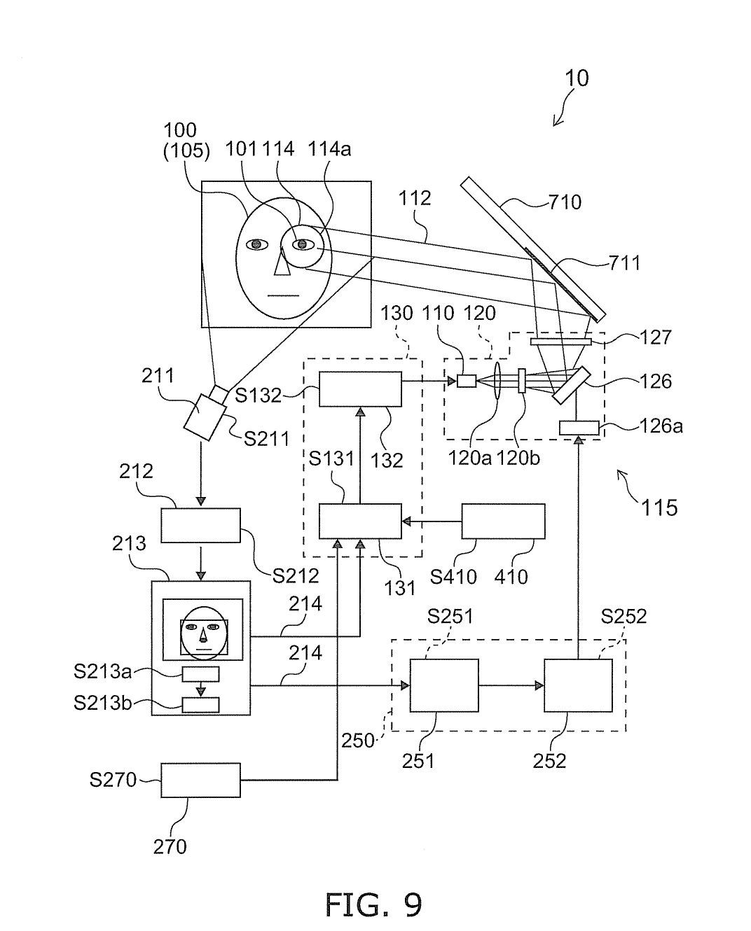

FIG. 9 is a schematic view illustrating the configuration and the operation of the automotive display system according to the first embodiment of the invention.

First, as illustrated in FIG. 8, information relating to the traveling state and the operating state of the vehicle 730 is acquired (step S270). In other words, as illustrated in FIG. 9, the operating condition of the vehicle 730 such as the traveling speed, the continuous traveling time, and the operation frequency of the steering wheel and the like is detected and acquired by the vehicle information acquisition unit 270. The vehicle information acquisition unit 270 also may acquire the information relating to the operating condition of the vehicle 730 detected by a portion provided outside the automotive display system 10. The vehicle information acquisition unit 270 may not be provided, and the information relating to the operating state of the vehicle 730 detected by a portion provided outside the automotive display system 10 may be supplied directly to the image data generation unit 130. Thereby, for example, the depth set position, the first width, and the like recited above may be set.

The position of the one eye 101 of the image viewer 100 is then detected (step S210).

Namely, as illustrated in FIG. 9, an image of the head 105 of the image viewer 100 is captured by the imaging unit 211 (step S211). The image captured by the imaging unit 211 undergoes image processing by the image processing unit 212 and is subsequently processed for easier calculations (step S212). Based on the data of the image processing by the image processing unit 212, the characteristic points of the face are first extracted by the calculation unit 213 (step S213a); based thereon, the coordinates of the eyeball positions are ascertained (step S213b). Thereby, the position of the one eye 101 is detected, and position data 214 of the detected one eye 101 is supplied to the control unit 250 and the image data generation unit 130.

Next, as illustrated in FIG. 8, the frontward information is then acquired by the frontward information acquisition unit 410 (step S410). Then, the road width and the like, for example, are compared to the first width and the second width. Data is then calculated relating to the depthward movement of the virtual leading vehicle image 180 to be displayed, the depth position where the virtual leading vehicle image 180 is to be displayed, and the like.

Then, the frontward display position T (Tx, Ty) is ascertained (step S410a). For example, the frontward display position T (Tx, Ty) is ascertained from the position of the frontward information where the virtual leading vehicle image 180 is to be displayed. The frontward display position T (Tx, Ty) also may be derived based on the preset distance.

The depth target position where the virtual leading vehicle image 180 is to be displayed is then set based on the frontward display position T (Tx, Ty) (step S410b). At this time, a correction may be performed based on the set depth distance Ls using the characteristics described in regard to FIG. 5.

Based thereon, the virtual leading vehicle image position P (Px, Py, Pz) is derived (step S410c). At this time, at least one of the tilt (α, β, and γ) and the size S of the virtual leading vehicle image 180 may be changed.

Based on this data, the image data including the virtual leading vehicle image 180 is generated (step S131). The generation of the image data may be performed by, for example, a generation unit 131 of the image data generation unit 130 illustrated in FIG. 9.

An image distortion correction processing is performed on the generated image data (step S132). The processing is performed by, for example, an image distortion correction processing unit 132 illustrated in FIG. 9. At this time, the image distortion correction processing may be performed based on the position data 214 of the one eye 101 of the image viewer 100. The image distortion correction processing also may be performed based on the characteristics of the reflector 711 provided on the windshield 710 and the image projection unit 115.

Then, the image data is output to the image formation unit 110 (step S130a).

The image formation unit 110 generates the light flux 112 including the image which includes the virtual leading vehicle image 180 based on the image data (step S110).

The projection unit 120 then projects the generated light flux 112 toward the one eye 101 of the image viewer 100 to perform the display of the image (step S120).

In regard to the aforementioned, the order of steps S270, S210, S410, S410a, S410b, S410c, S131, S132, S130a, S110, and S120 is interchangeable within the extent of technical feasibility, the steps may be implemented simultaneously, and the steps may be repeated partially or as an entirety as necessary.

A control signal generation unit 251 of the control unit 250 generates a motor control signal to control a motor of the drive unit 126a based on the position data 214 of the detected one eye 101 as illustrated in FIG. 9 (step S251).

Based on this signal, a drive unit circuit 252 generates a drive signal to control the motor of the drive unit 126a (step S252).

Thereby, the drive unit 126a is controlled and the mirror 126 is controlled to the prescribed angle. Thereby, it is possible to control the presentation position of the image to follow the head 105 (the one eye 101) of the image viewer 100 even in the case where the head 105 moves. The head 105 of the image viewer 100 does not move out of the image presentation position, and the practical viewing area can be increased.

As described above in regard to FIG. 3A, although the virtual leading vehicle image 180 is disposed (generated) at the predetermined depth set position in the case where the road width is not less than the predetermined first width, the invention is not limited thereto. That is, in the case where the road width is not less than the predetermined first width and a leading vehicle actually exists frontward as viewed from the vehicle 730, that is, the actual leading vehicle is within a prescribed distance from the position of the vehicle 730 and/or the depth set position, the virtual leading vehicle image 180 may be disposed (generated) at the depth position of the actual leading vehicle.

For example, in the case where the actual leading vehicle is positioned a certain distance from the depth set position where the virtual leading vehicle image 180 is to be displayed, disposing the virtual leading vehicle image 180 at the depth set position causes the virtual leading vehicle image 180 to appear overlaid on the image of the actual leading vehicle, and an incongruity occurs. Conversely, such an incongruity can be reduced by, for example, disposing the virtual leading vehicle image 180 at the position of the actual leading vehicle in the case where the actual leading vehicle is somewhat proximal to the depth set position and by disposing the virtual leading vehicle image 180 at the depth set position in the case where the position of the actual leading vehicle is somewhat distal to the depth set position.

In the case where a leading vehicle actually exists frontward, the virtual leading vehicle image 180 may be disposed at the depth position of the actual leading vehicle regardless of the road width. In such a case as well, a display having reduced incongruity can be realized.

Thus, the virtual leading vehicle image 180 can be disposed (generated) at the depth position of the leading vehicle in the case where the leading vehicle is detected within a predetermined distance in the frontward path of the vehicle 730. In the case where the frontward information acquired by the frontward information acquisition unit 410 using, for example, imaging functions and radar functions disposed on streets, buildings, etc., and imaging functions, radar functions, and GPS functions mounted in each of the vehicles includes information that the leading vehicle exists within the predetermined distance in the frontward path of the vehicle 730, the virtual leading vehicle image 180 may be disposed at the depth position of the leading vehicle.

In such a case, it is not necessary to select to display or not to display the virtual leading vehicle image 180 due to the existence or absence of the leading vehicle, and convenience improves.

Although the virtual leading vehicle image 180 may sometimes appear to have a size different from that of the actual leading vehicle because the virtual leading vehicle image 180 is generated based on the size of the vehicle 730, in such a case as well, the perceived depth position of the virtual leading vehicle image 180 may be the same as the depth position of the actual leading vehicle. In such a case, the size of the actual leading vehicle does not necessarily match the size of the vehicle 730. Therefore, the size of the virtual leading vehicle image 180 appears to be different from the size of the actual leading vehicle.

However, in the case where displaying the virtual leading vehicle image 180 having a size different from the size of the actual leading vehicle reduces the viewability, the display is not limited thereto. The size of the virtual leading vehicle image 180 may be modified to substantially the same size as the size of the actual leading vehicle. In the case where the size and the configuration of the actual leading vehicle are similar to those of the vehicle 730, the configuration of the virtual leading vehicle image 180 may be modified to imitate the image of the actual leading vehicle. Thereby, the images of the actual leading vehicle and the virtual leading vehicle image 180 do not unnaturally appear double, and a more natural display can be provided.

However, in such a case as well, the determination of the passable width and height of the road of travel (the road estimated to be traveled) may be determined based on the width and the height of the vehicle 730.

Although, as described above, the virtual leading vehicle image 180 may be disposed based on the frontward information, that is, the configuration including the curves and the like of the road of travel, at this time, for example, the virtual leading vehicle image 180 may be disposed at substantially the center of the road width. Thereby, traveling in substantially the center of the road can be encouraged. The position where the virtual leading vehicle image 180 is disposed in the road may be changed based on the existence/absence of an opposite lane, the existence/absence of a medial divider, the road width, the traffic volume, the existence/absence of pedestrians and the like, the traveling speed of the vehicle 730, etc., to enable safer travel support.

As described above, in the case where an obstacle and the like exist in the road of travel, the road width is considered to exclude the width of the obstacle, and the virtual leading vehicle image 180 is disposed, for example, in the center thereof. In the case where an oncoming vehicle exists in the road of travel, the road width is considered to be the road width excluding the width of the oncoming vehicle, and the virtual leading vehicle image 180 is disposed, for example, in the center thereof.

In such a case, the obstacle and the like and the oncoming vehicle recited above include objects existing in a portion obstructed from view as viewed from the vehicle 730. In other words, the frontward information includes information of whether or not the obstacle and the like and the oncoming vehicle exist in a portion obstructed from view as viewed from the vehicle 730. For example, the information relating to the obstacle and the like and the oncoming vehicle and the like may be acquired from components disposed on streets, buildings, etc., other vehicles, communication satellites, etc., using imaging functions and radar functions disposed on the streets, buildings, and the like and imaging functions, radar functions, and GPS functions mounted in each of the vehicles; and frontward information of obstacles and the like and oncoming vehicles and the like in portions obstructed from view can be obtained. The operations recited above may be executed also for portions obstructed from view, and the virtual leading vehicle image 180 may be generated and displayed. Thereby, safer travel support is possible. The information relating to the obstacle and the like and the oncoming vehicle recited above may be acquired by the frontward information acquisition unit 410.

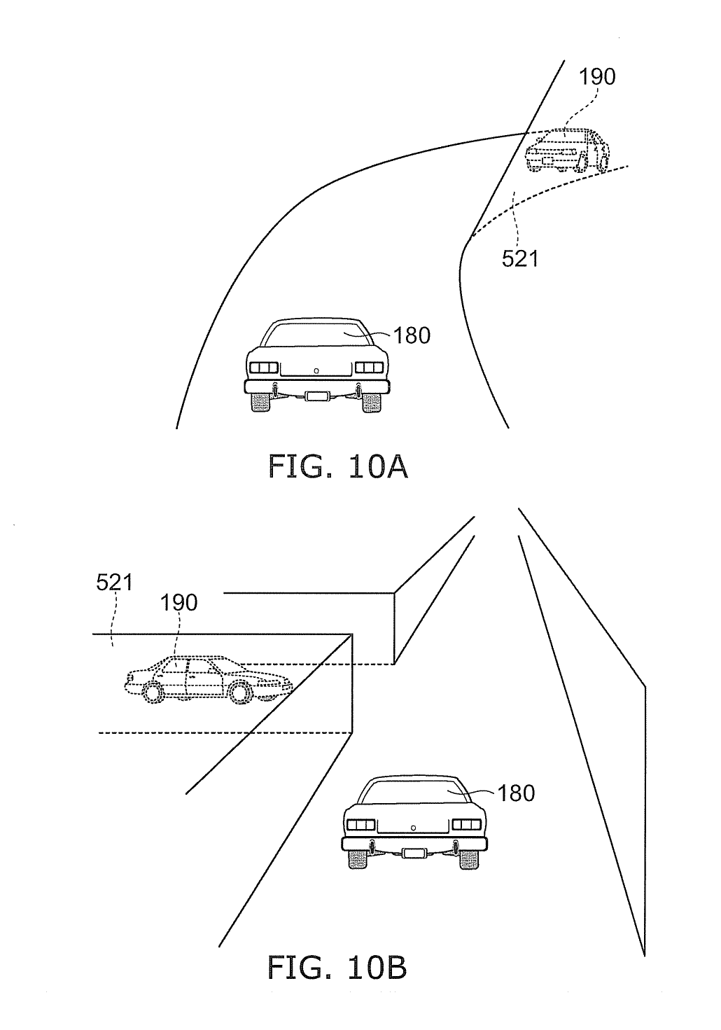

FIGS. 10A and 10B are schematic views illustrating operating states of the automotive display system according to the first embodiment of the invention.

Namely, FIGS. 10A and 10B illustrate the operating state for different conditions.

The road of travel of the vehicle 730 illustrated in FIG. 10A curves. In the case where an oncoming vehicle exists in a portion obstructed from view 521 as viewed from the vehicle 730, a virtual other vehicle image 190 may be displayed corresponding to the oncoming vehicle. Thereby, safer travel support can be performed for roads obstructed from view by curves and the like.

An intersection exists in the road of travel of the vehicle 730 illustrated in FIG. 10B. In the case where a vehicle moving closer in the travel direction of the vehicle 730, that is, another vehicle entering the intersection, exists in the portion obstructed from view 521 of the intersection, a virtual other vehicle image 190 corresponding to the other vehicle may be displayed. Thereby, safer travel support can be performed for roads obstructed from view by buildings, trees, etc., existing at intersections.

In regard to the aforementioned, the virtual other vehicle image 190 may be disposed at the depth position of the actual oncoming vehicle or the actual other vehicle entering the intersection as viewed from the vehicle 730, and a more natural and congruous recognition is possible. Thereby, the safety can be further improved.

In regard to the aforementioned, the virtual leading vehicle image 180 may be simultaneously displayed.

Thus, in the automotive display system 10, in the case where the frontward information obtained by the frontward information acquisition unit 410 includes information that another vehicle exists in a region obstructed by an obstacle and moves toward the vehicle 730 as viewed by the image viewer 100 within the predetermined distance from the vehicle 730, the image projection unit 115 further generates the virtual other vehicle image 190 (the second virtual image) corresponding to the detected other vehicle. The light flux 112 including the image which includes the generated virtual other vehicle image 190 can be projected toward the one eye 101 of the image viewer 100 based on the detected position of the one eye 101.

Examples according to this embodiment will now be described.

### First Example

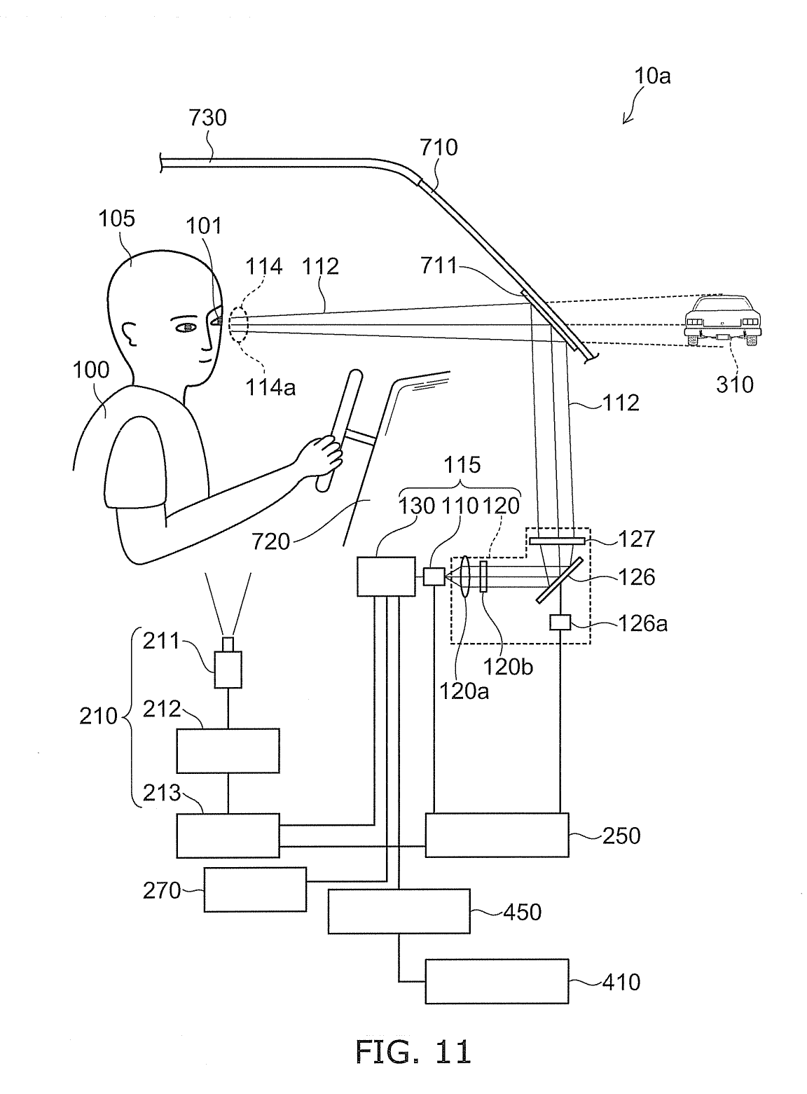

FIG. 11 is a schematic view illustrating the configuration of the automotive display system according to the first example of the invention.

An automotive display system 10a according to the first example illustrated in FIG. 11 further includes a route generation unit 450 that generates a route where the vehicle 730 is conjectured to travel. Otherwise, the automotive display system 10a may be similar to the automotive display system 10, and a description is omitted.

The route generation unit 450 calculates the route where the vehicle 730 is conjectured to travel based on the frontward information acquired by the frontward information acquisition unit 410 and, for example, the current position of the vehicle 730. At this time, for example, several route alternatives may be calculated; the image viewer 100, i.e., the operator of the vehicle 730, may be prompted to make a selection; and the route may be determined based on the result.

The image data generation unit 130 generates the image data including the virtual leading vehicle image 180 based on the route generated by the route generation unit 450.

The route generation unit 450 may be, for example, included in the image data generation unit 130, or in various components (including components described below) included in the automotive display system.

The route generation unit 450 may not be provided in the automotive display system 10a. For example, a portion corresponding to the route generation unit 450 may be provided in a navigation system provided separately in the vehicle 730. The image data generation unit 130 may obtain the route where the vehicle 730 is conjectured to travel generated by the navigation system and generate the image data including the virtual leading vehicle image 180.

A portion corresponding to the route generation unit 450 may be provided separately from the vehicle 730. In such a case, the image data generation unit 130 may obtain data from the portion corresponding to the route generation unit 450 provided separately from the vehicle 730 by, for example, wireless technology and generate the image data including the virtual leading vehicle image 180.

Thus, the route generation unit 450 (and the portion corresponding thereto) may be provided inside or outside the image data generation unit 130, inside or outside the automotive display system 10a, and inside or outside the vehicle 730. Hereinbelow, the route generation unit 450 (and the portion corresponding thereto) are omitted from the descriptions.

### Second Example

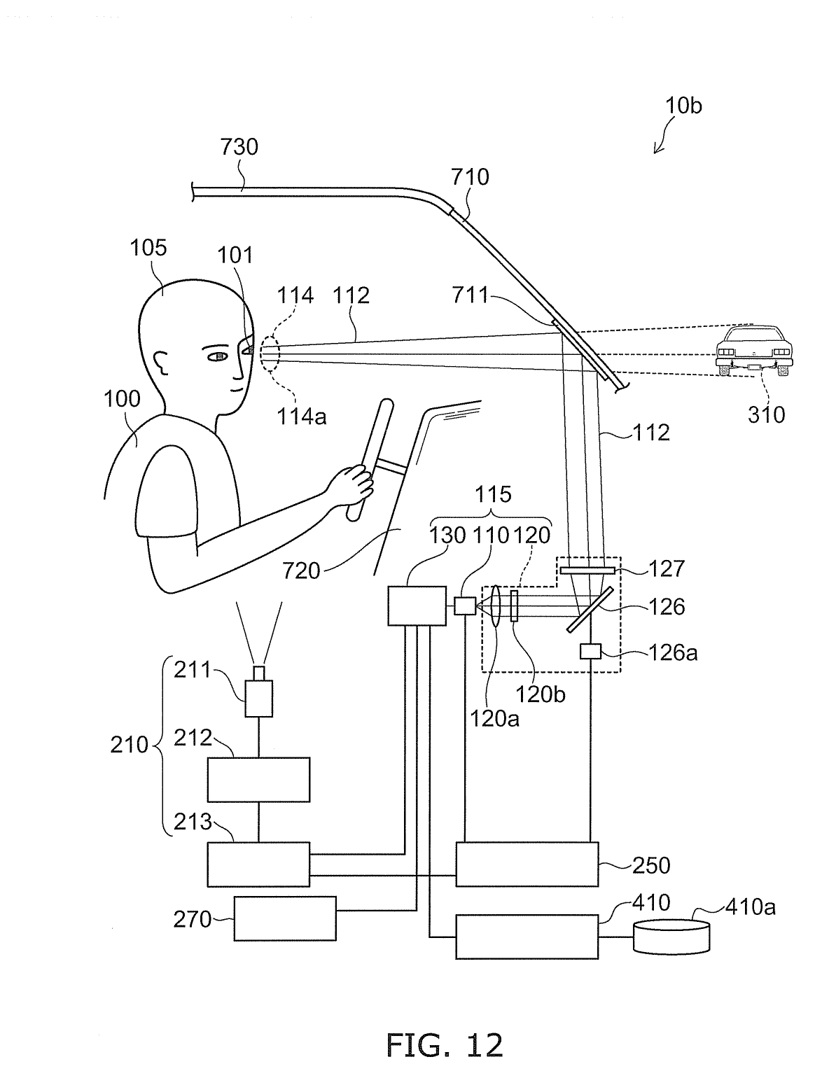

FIG. 12 is a schematic view illustrating the configuration of the automotive display system according to a second example of the invention.

An automotive display system 10b according to the second example illustrated in FIG. 12 includes a frontward information data storage unit 410a that pre-stores the frontward information of the vehicle 730. Thereby, the frontward information acquisition unit 410 acquires data relating to the frontward information pre-stored in the frontward information data storage unit 410a.

The frontward information data storage unit 410a may include a magnetic recording and reproducing device such as an HDD, a recording device based on optical methods such as CD and DVD, and various storage devices using semiconductors.

The frontward information data storage unit 410a may store various information outside of the vehicle 730 relating to configurations of streets and intersections, place names, buildings, target objects, and the like as the frontward information of the vehicle 730. Thereby, the frontward information acquisition unit 410 may read the frontward information from the frontward information data storage unit 410a based on the current position of the vehicle 730 and supply the frontward information to the image data generation unit 130. As described above, for example, the frontward display position T (Tx, Ty) corresponding to the virtual leading vehicle image 180 corresponding to the route where the vehicle 730 is conjectured to travel may be ascertained, and the operations recited above can be performed.

During the reading of the information stored in the frontward information data storage unit 410a, the current position of the vehicle 730 (the image viewer 100) may be ascertained by, for example, GPS and the like; the travel direction may be ascertained; and therefrom, the frontward information corresponding to the position and the travel direction may be read. Such a GPS and/or travel direction detection system may be included in the automotive display system 10b according to this example or provided separately from the automotive display system 10b to input the detection results of the GPS and/or travel direction detection system to the automotive display system 10b.

The frontward information data storage unit 410a recited above may be included in the frontward information acquisition unit 410.

The automotive display system 10 according to the first embodiment does not include the frontward information data storage unit 410a. In such a case, for example, a data storage unit corresponding to the frontward information data storage unit 410a may be provided separately from the automotive display system 10. Then, data may be input to the automotive display system 10 by the data storage unit corresponding to the frontward information data storage unit 410a provided externally. Thereby, the automotive display system 10 may execute the operations recited above.

In the case where the frontward information data storage unit 410a is not provided in the automotive display system 10, a portion that detects the frontward information such as that described below may be provided to provide the functions of the frontward information data storage unit 410a and similar functions.

### Third Example

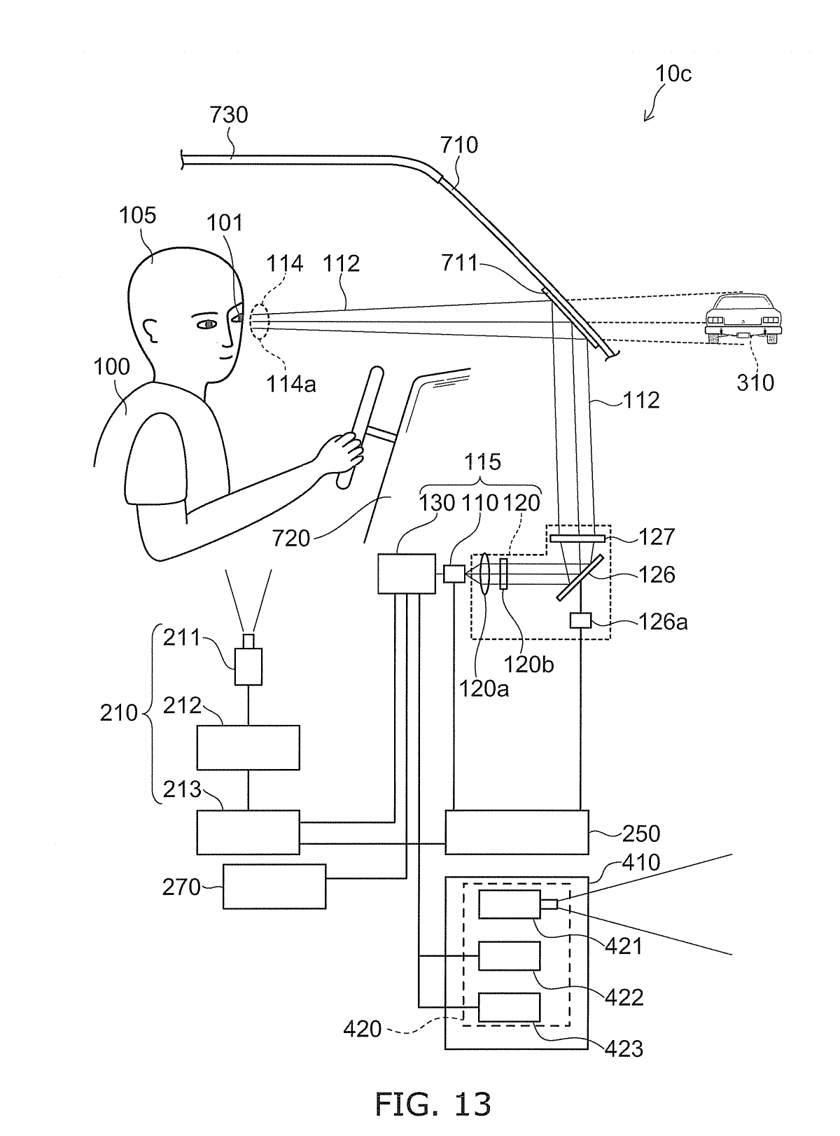

FIG. 13 is a schematic view illustrating the configuration of an automotive display system according to a third example of the invention.

In an automotive display system 10c according to the third example illustrated in FIG. 13, the frontward information acquisition unit 410 includes a frontward information detection unit 420 that detects frontward information of the vehicle 730. Specifically, the frontward information detection unit 420 includes a frontward imaging unit 421 (camera), an image analysis unit 422 that performs image analysis of the image captured by the frontward imaging unit 421, and a frontward information generation unit 423 that extracts various information relating to the configurations of the streets and the intersections, obstacles, and the like from the image analyzed by the image analysis unit 422 and generates the frontward information. Thereby, data relating to the frontward street conditions (the configurations of the streets and the intersections, obstacles, etc.) detected by the frontward information detection unit 420 can be acquired as the frontward information.

In such a case, the frontward imaging unit 421 may include, for example, a stereo camera and the like having multiple imaging units. Thereby, frontward information including information relating to the depth position can be easily acquired. Thereby, it is easy to designate the distance between the frontward image and the vehicle 730.

The frontward information detection unit 420 also may be configured to generate the frontward information by reading a signal from various guidance signal emitters such as beacons provided on the road of travel of the vehicle 730 and the like.

Thus, by providing the frontward information detection unit 420 that detects the frontward information of the vehicle 730 in the automotive display system 10c according to this example, the frontward information acquisition unit 410 can obtain ever-changing frontward information of the vehicle 730. Thereby, ever-changing frontward information can be acquired, the direction the vehicle 730 is traveling can be calculated with high precision, and the virtual leading vehicle image 180 can be disposed with higher precision.

Although the display of the virtual leading vehicle image 180 is described above, similar operations may be applied also to the virtual other vehicle image 190.

At least a portion of the various aspects using the frontward information data storage unit 410a recited above and at least a portion of the various aspects using the frontward information detection unit 420 recited above may be implemented in combination. Thereby, frontward information having higher precision can be acquired.

### Fourth Example

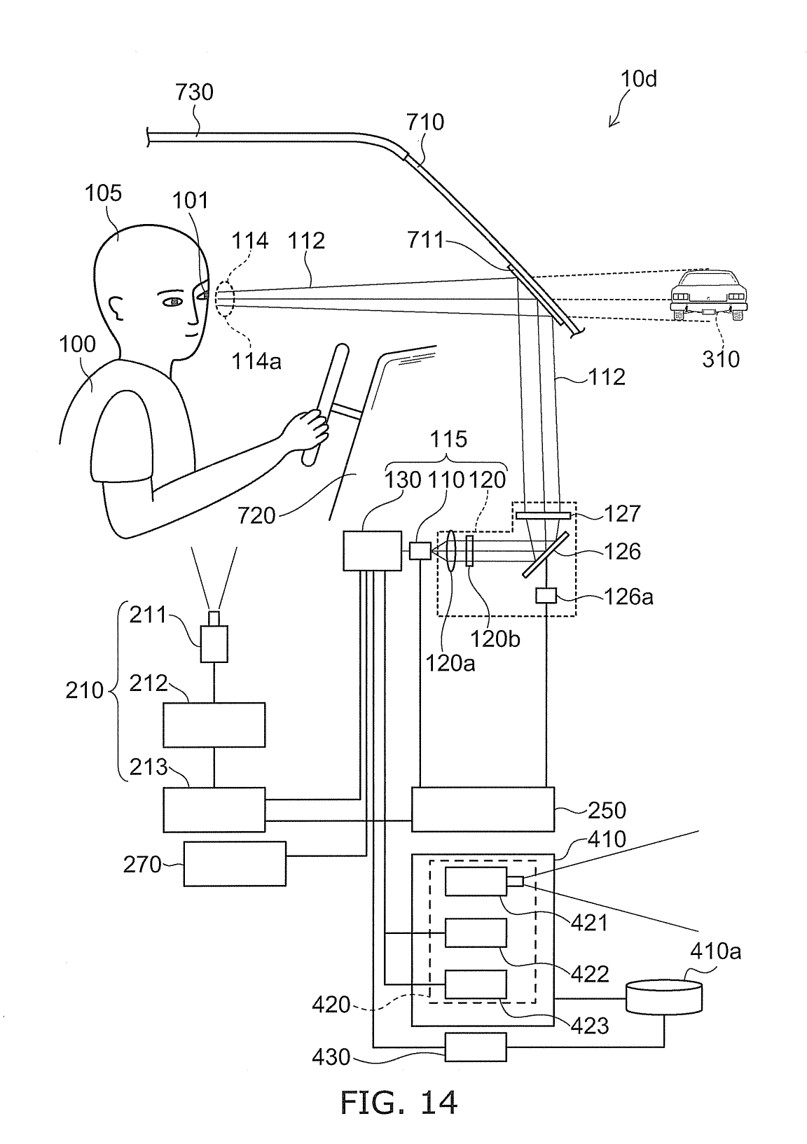

FIG. 14 is a schematic view illustrating the configuration of an automotive display system according to a fourth example of the invention.

An automotive display system 10d according to the fourth example illustrated in FIG. 14 further includes a vehicle position detection unit 430 that detects the position of the vehicle 730. The vehicle position detection unit 430 may use, for example, GPS. The virtual leading vehicle image 180 is generated based on the position of the vehicle 730 detected by the vehicle position detection unit 430.

Namely, the virtual leading vehicle image 180 is disposed based on the frontward information from the frontward information acquisition unit 410 and the position of the vehicle 730 detected by the vehicle position detection unit 430. Restated, the virtual leading vehicle image position P (Px, Py, Pz) is determined. The route where the vehicle 730 is conjectured to travel is ascertained based on the position of the vehicle 730 detected by the vehicle position detection unit 430. The mode of the display of the virtual leading vehicle image 180 and the virtual leading vehicle image position P (Px, Py, Pz) are determined based on the route. At this time, as described above, the virtual leading vehicle image position (Px, Py, Pz) is determined based further on the position E of the one eye (Ex, Ey, Ez).

Thereby, the virtual leading vehicle image 180 can be displayed based on an accurate position of the vehicle 730.

Although the frontward information acquisition unit 410 includes the frontward information detection unit 420 (including, for example, the frontward imaging unit 421, the image analysis unit 422, and the frontward information generation unit 423) and the frontward information data storage unit 410a in this specific example, the invention is not limited thereto. The frontward information detection unit 420 and the frontward information data storage unit 410a may not be provided.

For example, a data storage unit corresponding to the frontward information data storage unit 410a may be provided outside the vehicle 730 in which the automotive display system 10 is provided to input data from the data storage unit corresponding to the frontward information data storage unit 410a to the frontward information acquisition unit 410 of the automotive display system 10 using, for example, various wireless communication technology.

In such a case, appropriate data from the data stored in the data storage unit corresponding to the frontward information data storage unit 410a may be input to the automotive display system 10 by utilizing data of the position of the vehicle 730 from a GPS and/or a travel direction detection system provided in the vehicle 730 (which may be included in the automotive display system according to this embodiment or provided separately).

Although the display of the virtual leading vehicle image 180 is described above, similar operations may be applied to the virtual other vehicle image 190.

### Fifth Example

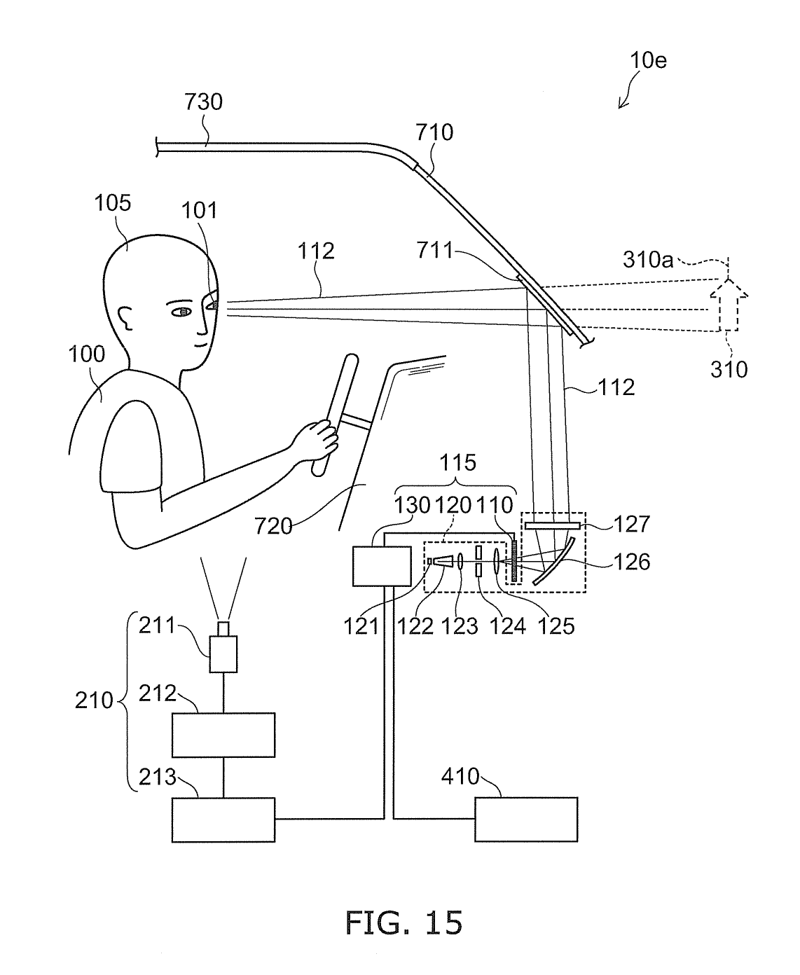

FIG. 15 is a schematic view illustrating the configuration of an automotive display system according to a fifth example of the invention.

The configuration of the image projection unit 115 of an automotive display system 10e according to the fifth example illustrated in FIG. 15 is different from that of FIG. 10 illustrated in FIG. 1. Specifically, the configurations of the image formation unit 110 and the projection unit 120 are different. Also, this specific example does not include the control unit 250. Otherwise, the automotive display system 10e is similar to the automotive display system 10, and a description is omitted.

In the automotive display system 10e according to this example, the image formation unit 110 may include, for example, various optical switches such as an LCD, a DMD, and a MEMS. The image formation unit 110 forms the image on the screen of the image formation unit 110 based on the image signal including the image which includes the virtual leading vehicle image 180 supplied by the image data generation unit 130.

The image formation unit 110 may include a laser projector, an LED projector, and the like. In such a case, the image is formed by a laser beam.

The case where an LCD is used as the image formation unit 110 will now be described.

The projection unit 120 projects the image formed by the image formation unit 110 onto the one eye 101 of the image viewer 100.

The projection unit 120 may include, for example, various light sources, projection lenses, mirrors, and various optical devices controlling the divergence angle (the diffusion angle).

In this specific example, the projection unit 120 includes, for example, a light source 121, a tapered light guide 122, a first lens 123, a variable aperture 124, a second lens 125, a movable mirror 126 having, for example, a concave configuration, and an aspherical Fresnel lens 127.

Assuming, for example, a focal distance f1 of the first lens 123 and a focal distance f2 of the second lens 125, the variable aperture 124 is disposed a distance of f1 from the first lens 123 and a distance of f2 from the second lens 125.

Light flux emerging from the second lens 125 enters the image formation unit 110 and is modulated by the image formed by the image formation unit 110 to form the light flux 112.

The light flux 112 passes through the aspherical Fresnel lens 127 via the mirror 126, is reflected by, for example, the reflector 711 provided on the windshield 710 (a transparent plate) of the vehicle 730 in which the automotive display system 10e is mounted, and is projected onto the one eye 101 of the image viewer 100. The image viewer 100 perceives a virtual image 310 formed at a virtual image formation position 310a via the reflector 711. Thus, the automotive display system 10e can be used as a HUD.

Various light sources may be used as the light source 121 including an LED, a high pressure mercury lamp, a halogen lamp, a laser, etc. The aspherical Fresnel lens 127 may be designed to control the shape (such as the cross sectional configuration) of the light flux 112 to match the configuration of, for example, the windshield 710.

By such a configuration, the automotive display system 10e can display the virtual leading vehicle image 180 at any depth position and perform a display easily viewable by the driver.

Although the display of the virtual leading vehicle image 180 is described above, similar operations also may be applied to the virtual other vehicle image 190.

In such a case as well, the control unit 250 may be provided to adjust at least one of the projection area 114a and the projection position 114 of the light flux 112 based on the position of the one eye 101 of the image viewer 100 detected by the position detection unit 210 by controlling the image projection unit 115. For example, the control unit 250 controls the projection position 114 by controlling the drive unit 126a linked to the mirror 126 to control the angle of the mirror 126. The control unit 250 may control the projection area 114a by, for example, controlling the variable aperture 124.

The route generation unit 450, the frontward imaging unit 421, the image analysis unit 422, the frontward information generation unit 423, the frontward information data storage unit 410a, and the vehicle position detection unit 430 described in regard to the first to fourth examples may be provided in the automotive display system 10e according to this example independently or in various combinations.

### Sixth Example

An automotive display system 10f (not illustrated) according to a sixth example of the invention is the automotive display system 10d according to the fourth example further including the route generation unit 450 described in regard to the automotive display system 10a according to the first example.

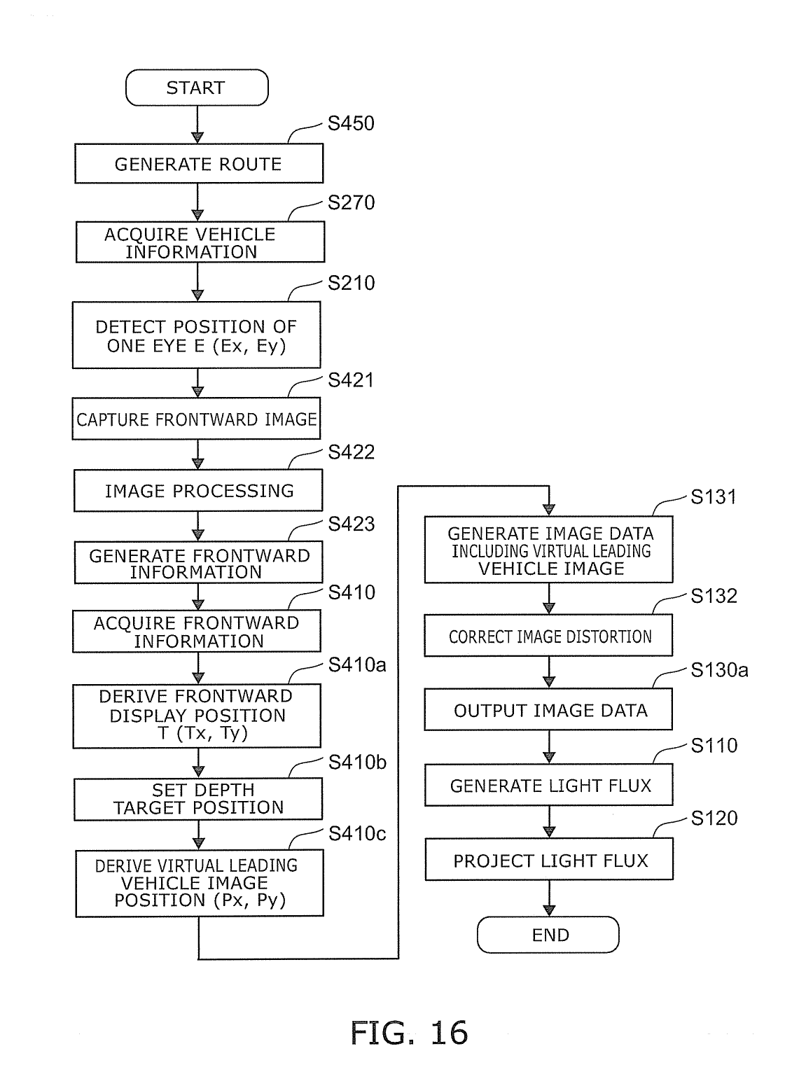

FIG. 16 is a flowchart illustrating the operation of the automotive display system according to the sixth example of the invention.

Namely, FIG. 16 illustrates the operation of the automotive display system 10f, which is the example where the route generation unit 450 is provided in the automotive display system 10d according to the fourth example. However, as described above, a portion having functions similar to the route generation unit 450 may be provided outside the automotive display system 10f or outside the vehicle 730. In such a case as well, the operations described below can be implemented.

First, as illustrated in FIG. 16, the route where the vehicle 730 is conjectured to travel is generated (step S450). The route may be generated using, for example, map information stored in the frontward information data storage unit 410a. Data relating to a destination input by the operator (the image viewer 100) and the like riding in the vehicle 730 may be used. Data relating to the current position of the vehicle 730 detected by the vehicle position detection unit 430 may be used as data relating to the position of a departure point. The data relating to the departure point may be input by the operator (the image viewer 100) and the like. As described above, multiple proposals of routes may be extracted; the operator (the image viewer 100) and the like may be prompted to select from the proposals; and the route input by the operator (the image viewer 100) and the like can thereby be used.

As illustrated in FIG. 16, the information relating to the traveling state and the operating state of the vehicle 730 is acquired (step S270).

The position of the one eye 101 of the image viewer 100 is detected (step S210).

Then, the frontward imaging unit 421 captures an image, for example, frontward of the vehicle 730 (step S421).

The image captured by the frontward imaging unit 421 then undergoes image analysis by the image analysis unit 422 (step S422).

The frontward information generation unit 423 then extracts various information relating to the configurations of the streets and the intersections, obstacles, and the like based on the image analyzed by the image analysis unit 422 to generate the frontward information (step S423).

The frontward information generated by the frontward information generation unit 423 is then acquired by the frontward information acquisition unit 410 (step S410). The road width and the like, for example, are compared to the first width and the second width. Data is then calculated relating to the depthward movement of the virtual leading vehicle image 180 to be displayed, the depth position where the virtual leading vehicle image 180 is to be displayed, and the like.

Then, the frontward display position T (Tx, Ty) is derived as the position of the frontward information where the virtual leading vehicle image 180 is to be disposed based on the preset route and the frontward information (step S410a). For example, it is assumed that the position where the virtual leading vehicle image 180 is displayed is on the street 50 m frontward of the vehicle 730 corresponding to the route set as recited above. At this time, the frontward imaging unit 421 recognizes the position 50 m ahead on the frontward street. The distance is measured, and the frontward display position T (Tx, Ty) is derived.

The depth target position is then set (step S410b). At this time, a correction may be performed based on the set depth distance Ls using the characteristics described in regard to FIG. 5.

Based thereon, the virtual leading vehicle image position P (Px, Py) is derived (step S410c). In other words, the centroid position coordinates, for example, of the virtual leading vehicle image 180, i.e., the virtual leading vehicle image position P (Px, Py), are derived from the position of the one eye 101 of the image viewer 100 and the frontward display position T (Tx, Ty).

Thereafter, similarly to FIG. 8, the image data including the virtual leading vehicle image 180 is generated based on the data of the virtual leading vehicle image position P (Px, Py) (step S131).

An image distortion correction processing is then performed on the generated image data (step S132).

Then, the image data is output to the image formation unit 110 (step S130a).

The image formation unit 110 generates the light flux 112 including the image which includes the virtual leading vehicle image 180 based on the image data (step S110).

The projection unit 120 then projects the generated light flux 112 toward the one eye 101 of the image viewer 100 to perform the display of the image (step S120).

In regard to the aforementioned, the order of steps S450, S270, S210, S421, S422, S423, S410, S410a, S410b, S410c, S131, S132, S130a, S110, and S120 is interchangeable within the extent of technical feasibility, the steps may be implemented simultaneously, and the steps may be repeated partially or as an entirety as necessary.

As described above, in the automotive display system according to this embodiment and the various examples recited above, the depth position is calculated by replacing with two dimensional coordinates. When the image viewer 100 is viewing frontward in the case where the frontward display position T (Tx, Ty) is overlaid in the frontward direction thereof, the vertical direction corresponds to the depth position. In the case where the frontward display position T (Tx, Ty) is shifted from the frontward direction, the left and right direction also corresponds to the depth position. The depth position is prescribed based on these image coordinates.

Similarly, in the case where the virtual leading vehicle image position P (Px, Py) is overlaid in the frontward direction thereof, the vertical direction corresponds to the depth position. In the case where the virtual leading vehicle image position P (Px, Py) is shifted from the frontward direction, the left and right direction, in addition to the vertical direction, also corresponds to the depth position. Thus, the vertical position (and the position in the left and right direction) of the display image plane displayed by the automotive display system is taken by the operator (the image viewer 100) to be depth position information. Thereby, the depth disposition position of the virtual leading vehicle image 180 is determined from the positions among the position of the operator, the frontward position, and the position of the display image plane.

### Second Embodiment

A display method according to a second embodiment of the invention will now be described.

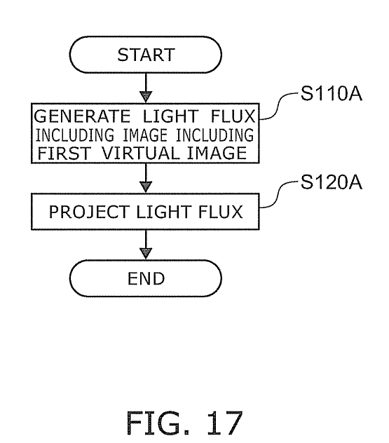

FIG. 17 is a flowchart illustrating the display method according to the second embodiment of the invention.

In the display method according to the second embodiment of the invention illustrated in FIG. 17, first, based on the frontward information, i.e., the information relating to the frontward path of the vehicle 730, the virtual leading vehicle image 180 (the first virtual image) having a size corresponding to at least one of the width and the height of the vehicle 730 is generated at a corresponding position in the scenery of the frontward path; and a light flux including the image which includes the generated virtual leading vehicle image 180 is generated (step S110A).

The position of the one eye 101 of the image viewer 100 riding in the vehicle 730 is detected, and the light flux 112 is projected toward the one eye 101 of the image viewer 100 based on the detected position of the one eye 101 (step S120A).

Thereby, the virtual leading vehicle image 180 can be disposed at any depth position, and a display method is provided that performs a display easily viewable by the driver.

Further, the virtual leading vehicle image 180 is generated based on the detected position of the one eye 101. Thereby, the depth position can be perceived with higher precision in regard to the virtual leading vehicle image 180 disposed at any depth position. Thus, according to this display method, a monocular display method can be provided such that the display of the virtual leading vehicle image 180 and the like can be perceived with high positional precision at any depth position.

At this time in the display method according to this embodiment, as described above in regard to FIGS. 3A to 3C, the virtual leading vehicle image 180 may be disposed at the preset depth set position in the case where the frontward information acquired by the frontward information acquisition unit 410 includes a width of at least one of a passable horizontal direction and a passable perpendicular direction of the road where the vehicle 730 is estimated to travel and the width is not less than the predetermined first width.

The virtual leading vehicle image 180 may be disposed at a position more distal than the depth set position in the case where the width is narrower than the first width and not less than a predetermined second width, where the second width is narrower than the first width. The virtual leading vehicle image 180 may be disposed at a position based on a position where the road is narrower than the second width in the case where the width is narrower than the second width.

In the case where the width is narrower than the first width and not less than the second width, the virtual leading vehicle image 180 may be disposed to move away from the depth set position.

For such dispositions of the virtual leading vehicle image 180 in the depth direction, the depth position can be perceived more accurately by performing the correction according to the characteristics of the perception of a human relating to depth described in regard to FIG. 5.

Hereinabove, exemplary embodiments of the invention are described with reference to specific examples. However, the invention is not limited to these specific examples. For example, one skilled in the art may appropriately select specific configurations of components of automotive display systems and display methods from known art and similarly practice the invention. Such practice is included in the scope of the invention to the extent that similar effects thereto are obtained.

Further, any two or more components of the specific examples may be combined within the extent of technical feasibility; and are included in the scope of the invention to the extent that the purport of the invention is included.

Moreover, all automotive display systems and display methods practicable by an appropriate design modification by one skilled in the art based on the automotive display systems and the display methods described above as exemplary embodiments of the invention also are within the scope of the invention to the extent that the purport of the invention is included.

Furthermore, various modifications and alterations within the spirit of the invention will be readily apparent to those skilled in the art. All such modifications and alterations should therefore be seen as within the scope of the invention.

1. An automotive display system, comprising:
a frontward information acquisition unit configured to acquire frontward information, the frontward information including information relating to a frontward path of a vehicle;
a position detection unit configured to detect a position of one eye of an image viewer riding in the vehicle; and
an image projection unit configured to generate a first virtual image at a corresponding position in scenery of the frontward path based on the frontward information acquired by the frontward information acquisition unit and project a light flux including an image including the generated first virtual image toward the one eye of the image viewer based on the detected position of the one eye, the first virtual image having a size corresponding to at least one of a vehicle width and a vehicle height.

2. The system according to claim 1, wherein
the frontward information acquired by the frontward information acquisition unit includes a width of at least one of a passable horizontal direction and a passable perpendicular direction of a road where the vehicle is estimated to travel, and
the first virtual image is generated at a predetermined depth set position in the scenery of the frontward path in the case where the width is not less than a predetermined first width.

3. The system according to claim 2, wherein the width is ascertained based on at least one of an obstacle existing in the road and another vehicle moving toward the vehicle.

4. The system according to claim 2, wherein a depth target position where the first virtual image is generated is disposed more distally as viewed by the image viewer than a depth position where the first virtual image is generated in the scenery of the frontward path in the case where the width is not less than a predetermined first width and a distance from the vehicle to the depth position where the first virtual image is generated in the scenery of the frontward path is not less than a preset distance.

5. The system according to claim 2, wherein a target position where the first virtual image is generated in the image is disposed on an outer side of a position in the image corresponding to a position where the first virtual image is generated in the scenery of the frontward path as viewed from a center of the image in the case where the width is not less than a predetermined first width and a distance from the vehicle to the depth position where the first virtual image is generated in the scenery of the frontward path is not less than a preset distance.

6. The system according to claim 2, wherein
the first virtual image is generated at a position more distal than the depth set position as viewed by the image viewer in the case where the width is less than the first width and not less than a predetermined second width, the second width being less than the first width, and
the first virtual image is generated at a position based on a position where the road is less than the second width in the case where the width is less than the second width.

7. The system according to claim 6, wherein the first virtual image is generated to move away from the depth set position as viewed by the image viewer in the case where the width is less than the first width and not less than the second width.

8. The system according to claim 7, wherein a depth target position where the first virtual image is generated is disposed more proximally as viewed by the image viewer than a depth position where the first virtual image is generated in the scenery of the frontward path in the case where the width is less than the first width and not less than the second width and a distance from the vehicle to the depth position where the first virtual image is generated in scenery of the frontward path is not less than a preset distance.

9. The system according to claim 7, wherein a target position where the first virtual image is generated in the image is disposed on an inner side of a position in the image corresponding to a position where the first virtual image is generated in the scenery of the frontward path as viewed from a center of the image in the case where the width is less than the first width and not less than the second width and a distance from the vehicle to the depth position where the first virtual image is generated in the scenery of the frontward path is not less than a preset distance.

10. The system according to claim 1, wherein the first virtual image is generated at a size of the vehicle perceived by the image viewer when viewing the vehicle in the case where the vehicle exists at a depth position where the first virtual image is generated in the scenery of the frontward path.

11. The system according to claim 1, wherein the first virtual image is generated at a depth position of a leading vehicle in the case where the frontward information includes information that the leading vehicle exists within a predetermined distance in the frontward path.

12. The system according to claim 1, wherein the image projection unit further generates a second virtual image at a corresponding position in the scenery of the frontward path in the image in the case where the frontward information includes information that another vehicle exists in a region obstructed as viewed by the image viewer and is moving toward the vehicle within a predetermined distance from the vehicle, the second virtual image corresponding to the detected other vehicle.

13. The system according to claim 1, wherein the first virtual image is generated based further on the detected position of the one eye.

14. The system according to claim 1, wherein the image projection unit includes:
an image data generation unit configured to generate image data including the first virtual image;
an image formation unit configured to form the image including the first virtual image based on the image data generated by the image data generation unit;
a projection unit configured to project the light flux including the image formed by the image formation unit onto the one eye of the image viewer; and
a control unit configured to adjust at least one of a projection area and a projection position of the light flux by controlling the image projection unit.

15. The system according to claim 1, wherein the frontward information acquisition unit acquires frontward information from data relating to pre-stored frontward information.

16. The system according to claim 1, wherein the frontward information acquisition unit includes a frontward information detection unit configured to detect the frontward information of the vehicle, the frontward information acquisition unit acquiring the frontward information detected by the frontward information detection unit.

17. The system according to claim 1, further comprising a route generation unit configured to generate a route where the vehicle is conjectured to travel, the first virtual image being generated based on the route generated by the route generation unit.

18. The system according to claim 1, further comprising a vehicle position detection unit configured to detect a position of the vehicle, the corresponding position in the scenery of the frontward path where the first virtual image is correspondingly generated being determined based on the position of the vehicle detected by the vehicle position detection unit.

19. A display method, comprising:
generating a first virtual image at a corresponding position in scenery of a frontward path of a vehicle and generating a light flux including an image including the generated first virtual image based on frontward information including information relating to the frontward path, the first virtual image having a size corresponding to at least one of a vehicle width and a vehicle height; and
detecting a position of one eye of an image viewer riding in the vehicle and projecting the light flux toward the one eye of the image viewer based on the detected position of the one eye.
